(19) United States
(12) Patent Application Publication
(10) Pub. No.: US 2024/0371052 A1
(43) Pub. Date: Nov. 7, 2024

(54) INFORMATION PROCESSING APPARATUS, INFORMATION PROCESSING METHOD, AND PROGRAM

(71) Applicant: FUJIFILM Corporation, Tokyo (JP)

(72) Inventors: Yasunobu KISHINE, Saitama-shi (JP); Kazuyoshi OKADA, Saitama-shi (JP); Atsushi KAWANAGO, Saitama-shi (JP); Takashi KUNUGISE, Saitama-shi (JP); Yuya HIRAKAWA, Saitama-shi (JP)

(73) Assignee: FUJIFILM Corporation, Tokyo (JP)

(21) Appl. No.: 18/779,091

(22) Filed: Jul. 22, 2024

Related U.S. Application Data
(63) Continuation of application No. PCT/JP2022/041773, filed on Nov. 9, 2022.

(30) Foreign Application Priority Data
Mar. 28, 2022 (JP) 2022-052533

(51) Int. Cl. G06T 11/00; G06T 5/50; G06V 10/143; G06V 10/764

(52) U.S. Cl. CPC G06T 11/001; G06T 5/50; G06V 10/143; G06V 10/764; G06T 2207/10036; G06T 2207/20224

(57) ABSTRACT

An information processing apparatus includes a processor. The processor is configured to generate a channel image for each channel by performing assignment processing of assigning a plurality of different spectral images to different channels, and generate a first pseudo-color image based on a plurality of the channel images. The assignment processing includes processing of generating the channel image based on an operation including subtraction for a first spectral image among the plurality of spectral images.

This application is a continuation application of International Application No. PCT/JP2022/041773, filed Nov. 9, 2022, the disclosure of which is incorporated herein by reference in its entirety. Further, this application claims priority under 35 USC 119 from Japanese Patent Application No. 2022-052533 filed Mar. 28, 2022, the disclosure of which is incorporated by reference herein.

### BACKGROUND OF THE INVENTION

### 1. Field of the Invention

The disclosed technology relates to an information processing apparatus, an information processing method, and a program.

### 2. Description of the Related Art

WO2019/151029A discloses an imaging apparatus including a white color light source unit that irradiates a target object with white color light, an imaging unit that captures a multispectral image of the target object, a target object identification unit that specifies a wavelength of light most suitable for analyzing the target object as an effective wavelength from the multispectral image of the target object irradiated with the white color light, and a wavelength-selective light source unit that irradiates the target object with light having the effective wavelength.

JP2018-098341A discloses an imaging element comprising a first pixel comprising a thin metal film filter that allows transmission of light having a first frequency band, and a second pixel comprising a color filter that allows transmission of light having a second frequency band wider than the first frequency band.

JP2021-135404A discloses a lens device comprising an optical system, an optical member, an irradiation device, and a control unit. The optical system includes a lens that forms an optical image of a subject. The optical member is an optical member disposed at a pupil position of the optical system or near the pupil position and includes a frame having a plurality of opening regions, a plurality of optical filters that are disposed in the plurality of opening regions and that include two or more optical filters which allow transmission of light components having wavelength ranges at least partially different from each other, and a plurality of polarizing filters that are disposed in the plurality of opening regions and that have different polarization directions. The irradiation device irradiates the subject with illumination light. The control unit controls at least one of the optical system, the optical member, or the irradiation device. The control unit changes spectral characteristics of the light emitted from the optical system for the plurality of opening regions.

JP2010-025750A discloses an image processing apparatus that processes a multiband image captured using a plurality of band-pass filters. The image processing apparatus comprises auxiliary light source designation means for designating an auxiliary light source different from a main light source, spectral estimation means for obtaining a spectral image from a multiband image, and image separation means for separating the spectral image obtained by the spectral estimation means into an image under the main light source and an image under the auxiliary light source based on a spectrum of the auxiliary light source designated by the auxiliary light source designation means.

### SUMMARY OF THE INVENTION

An embodiment according to the disclosed technology provides an information processing apparatus, an information processing method, and a program that can implement color adjustment of a high degree of freedom in pseudo-coloring a plurality of spectral images, compared to a case where, for example, a channel image is generated based on an operation including only addition with respect to a first spectral image among a plurality of different spectral images.

A first aspect according to the disclosed technology is an information processing apparatus comprising a processor, in which the processor is configured to generate a channel image for each channel by performing assignment processing of assigning a plurality of different spectral images to different channels, and generate a first pseudo-color image based on a plurality of the channel images, and the assignment processing includes processing of generating the channel image based on an operation including subtraction for a first spectral image among the plurality of spectral images.

A second aspect according to the disclosed technology is the information processing apparatus according to the first aspect, in which the operation is a multiply-accumulate operation including the first spectral image, and the subtraction is implemented by including a negative value in a coefficient of the first spectral image in the multiply-accumulate operation.

A third aspect according to the disclosed technology is the information processing apparatus according to the second aspect, in which the coefficient is set to a value with which a range of the first pseudo-color image falls within a representation range of a display medium on which the first pseudo-color image is displayed.

A fourth aspect according to the disclosed technology is the information processing apparatus according to any one of the first aspect to the third aspect, in which the plurality of spectral images include polarization information and/or first wavelength information, and the number of the plurality of spectral images is greater than or equal to the number of the channels.

A fifth aspect according to the disclosed technology is the information processing apparatus according to any one of the first aspect to the fourth aspect, in which the plurality of spectral images are images obtained by imaging performed by an image sensor including a polarizer, the processor is configured to perform registration processing on the first spectral image, and the subtraction is performed on the first spectral image on which the registration processing is performed.

A sixth aspect according to the disclosed technology is the information processing apparatus according to any one of the first aspect to the fifth aspect, in which the first pseudo-color image is an image in which discriminability of second wavelength information is increased with respect to a second pseudo-color image for which only addition is included in the operation.

A seventh aspect according to the disclosed technology is the information processing apparatus according to any one of the first aspect to the sixth aspect, in which the processor is configured to classify an image generated based on the plurality of spectral images into a plurality of regions, and the operation is performed based on color information set for the plurality of regions.

An eighth aspect according to the disclosed technology is the information processing apparatus according to any one of the first aspect to the seventh aspect, in which the different channels are channels of three primary colors.

A ninth aspect according to the disclosed technology is the information processing apparatus according to any one of the first aspect to the eighth aspect, in which the processor is configured to output data for displaying the first pseudo-color image to a display device.

A tenth aspect according to the disclosed technology is an information processing method comprising generating a channel image for each channel by performing assignment processing of assigning a plurality of different spectral images to different channels, and generating a first pseudo-color image based on a plurality of the channel images, in which the assignment processing includes processing of generating the channel image based on an operation including subtraction for a first spectral image among the plurality of spectral images.

An eleventh aspect according to the disclosed technology is a program for causing a computer to execute a specific process comprising generating a channel image for each channel by performing assignment processing of assigning a plurality of different spectral images to different channels, and generating a first pseudo-color image based on a plurality of the channel images, in which the assignment processing includes processing of generating the channel image based on an operation including subtraction for a first spectral image among the plurality of spectral images.

### BRIEF DESCRIPTION OF THE DRAWINGS

FIG. 1 is a block diagram illustrating an example of a hardware configuration of an imaging apparatus according to an embodiment.

FIG. 2 is an exploded perspective view illustrating an example of a photoelectric conversion element according to the embodiment.

FIG. 3 is a block diagram illustrating an example of a functional configuration for implementing image display processing according to the embodiment.

FIG. 4 is a block diagram illustrating an example of operations of an output value acquisition unit and an interference removal processing unit according to the embodiment.

FIG. 5 is a block diagram illustrating an example of an operation of a registration processing unit according to the embodiment.

FIG. 6 is a block diagram illustrating an example of an operation of an initial image generation unit according to the embodiment.

FIG. 7 is a block diagram illustrating an example of an operation of an initial image output unit according to the embodiment.

FIG. 8 is a block diagram illustrating an example of operations of a region setting determination unit and a region setting unit according to the embodiment.

FIG. 9 is a block diagram illustrating an example of operations of a color setting determination unit and a gain setting unit according to the embodiment.

FIG. 10 is a block diagram illustrating an example of an operation of a pseudo-color image generation unit according to the embodiment.

FIG. 11 is a block diagram illustrating an example of an operation of a pseudo-color image output unit according to the embodiment and a first example of a pseudo-color image.

FIG. 12 is a block diagram illustrating an example of the operation of the pseudo-color image output unit according to the embodiment and a second example of the pseudo-color image.

FIG. 13 is a block diagram illustrating an example of the operation of the pseudo-color image output unit according to the embodiment and a third example of the pseudo-color image.

FIG. 14 is a block diagram illustrating an example of the operation of the pseudo-color image output unit according to the embodiment and a fourth example of the pseudo-color image.

FIG. 15 is a flowchart illustrating an example of a flow of the image display processing according to the embodiment.

### DESCRIPTION OF THE PREFERRED EMBODIMENTS

Hereinafter, an example of an embodiment of an information processing apparatus, an information processing method, and a program according to the disclosed technology will be described with reference to the accompanying drawings.

First, terms used in the following description will be described.

I/F refers to the abbreviation for “Interface”. CMOS refers to the abbreviation for “Complementary Metal Oxide Semiconductor”. CCD refers to the abbreviation for “Charge Coupled Device”. NVM refers to the abbreviation for “Non-Volatile Memory”. RAM refers to the abbreviation for “Random Access Memory”. CPU refers to the abbreviation for “Central Processing Unit”. GPU refers to the abbreviation for “Graphics Processing Unit”. EEPROM refers to the abbreviation for “Electrically Erasable and Programmable Read Only Memory”. HDD refers to the abbreviation for “Hard Disk Drive”. LiDAR refers to the abbreviation for “Light Detection and Ranging”. TPU refers to the abbreviation for “Tensor Processing Unit”. SSD refers to the abbreviation for “Solid State Drive”. USB refers to the abbreviation for “Universal Serial Bus”. ASIC refers to the abbreviation for “Application Specific Integrated Circuit”. FPGA refers to the abbreviation for “Field-Programmable Gate Array”. PLD refers to the abbreviation for “Programmable Logic Device”. SOC refers to the abbreviation for “System-on-a-Chip”. IC refers to the abbreviation for “Integrated Circuit”.

In the description of the present specification, the term “same” refers to not only being completely the same but also being the same in a sense including an error that is generally allowed in the technical field of the disclosed technology and that does not contradict the gist of the disclosed technology. In the description of the present specification, the term “orthogonal” refers to not only being completely orthogonal but also being orthogonal in a sense including an error that is generally allowed in the technical field of the disclosed technology and that does not contradict the gist of the disclosed technology. In the description of the present specification, the term “straight line” refers to not only a completely straight line but also a straight line in a sense including an error that is generally allowed in the technical field of the disclosed technology and that does not contradict the gist of the disclosed technology.

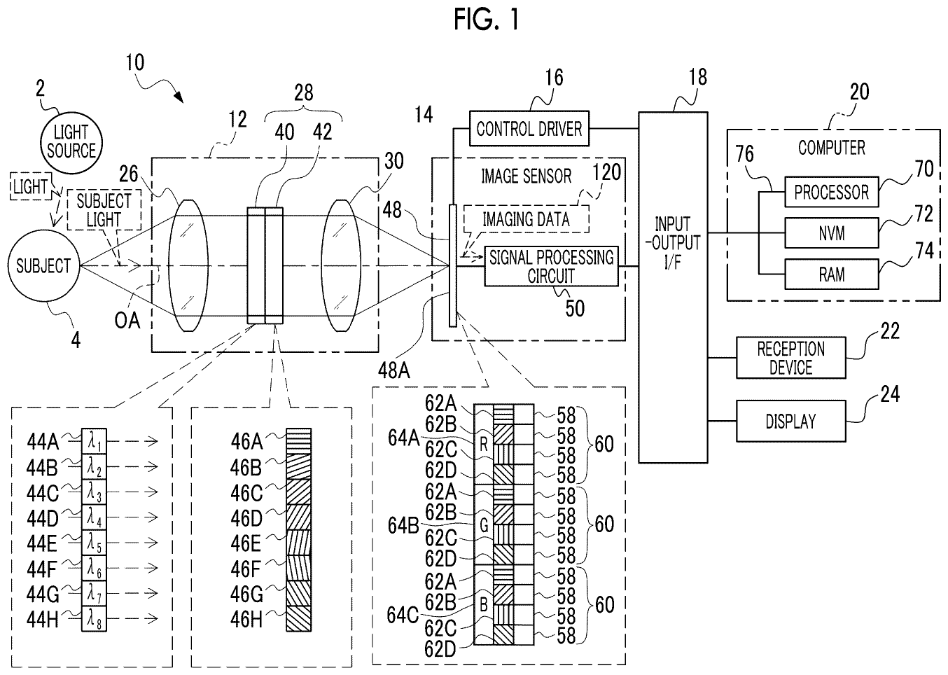

For example, as illustrated in FIG. 1, an imaging apparatus 10 is a multispectral camera that can output a pseudo-colored multispectral image, and comprises an optical system 12, an image sensor 14, a control driver 16, an input-output I/F 18, a computer 20, a reception device 22, and a display 24. The imaging apparatus is an example of the “information processing apparatus” according to the disclosed technology.

The optical system 12 includes a first lens 26, a pupil-splitting filter 28, and a second lens 30. The first lens 26, the pupil-splitting filter 28, and the second lens 30 are disposed in an order of the first lens 26, the pupil-splitting filter 28, and the second lens 30 along an optical axis OA of the imaging apparatus 10 from a side closer to a subject 4 to a side closer to the image sensor 14. The first lens 26 causes light (hereinafter, referred to as “subject light”) obtained by reflection of light emitted from a light source 2 by the subject 4 to be transmitted through the pupil-splitting filter 28. The second lens 30 forms an image of the subject light transmitted through the pupil-splitting filter 28 on a light-receiving surface 48A of a photoelectric conversion element 48 provided in the image sensor 14.

The pupil-splitting filter 28 includes a spectral filter 40 and a polarizing filter 42. The spectral filter 40 includes a filter 44A to a filter 44H, and the polarizing filter 42 includes a polarizer 46A to a polarizer 46H. While a state where the filter 44A to the filter 44H are arranged in a straight line along a direction orthogonal to the optical axis OA is illustrated in FIG. 1 for convenience, the filter 44A to the filter 44H are arranged along a direction about the optical axis OA.

The filter 44A has a first transmission wavelength range λ₁. The filter 44B has a second transmission wavelength range λ₂. The filter 44C has a third transmission wavelength range λ₃. The filter 44D has a fourth transmission wavelength range λ₄. The filter 44E has a fifth transmission wavelength range λ₅. The filter 44F has a sixth transmission wavelength range λ₆. The filter 44G has a seventh transmission wavelength range λ₇. The filter 44H has an eighth transmission wavelength range λ₈.

The first transmission wavelength range λ₁ to the eighth transmission wavelength range λ₈ are wavelength ranges different from each other. For example, in the example illustrated in FIG. 1, the first transmission wavelength range λ₁ is set to 435 nm. The second transmission wavelength range λ₂ is set to 495 nm. The third transmission wavelength range λ₃ is set to 555 nm. The fourth transmission wavelength range λ₄ is set to 615 nm. The fifth transmission wavelength range λ₅ is set to 675 nm. The sixth transmission wavelength range λ₆ is set to 735 nm. The seventh transmission wavelength range λ₇ is set to 795 nm. The eighth transmission wavelength range λ₈ is set to 855 nm. Each wavelength range illustrated here is merely an example. The first transmission wavelength range λ₁ to the eighth transmission wavelength range λ₈ each may be set to any wavelength range and are preferably wavelength ranges different from each other.

Hereinafter, the filter 44A to the filter 44H will be referred to as “filters 44” unless necessary to distinguish the filter 44A to the filter 44H from each other. In addition, the first transmission wavelength range λ to the eighth transmission wavelength range λ₈ will be referred to as “transmission wavelength ranges λ” unless necessary to distinguish the first transmission wavelength range λ₁ to the eighth transmission wavelength range λ₈ from each other.

The polarizer 46A to the polarizer 46H are overlaid with the filter 44A to the filter 44H, respectively. The polarizer 46A is a polarizer of which an angle of a transmission axis is set to 0°. The polarizer 46B is a polarizer of which an angle of a transmission axis is set to 20°. The polarizer 46C is a polarizer of which an angle of a transmission axis is set to 40°. The polarizer 46D is a polarizer of which an angle of a transmission axis is set to 60°. The polarizer 46E is a polarizer of which an angle of a transmission axis is set to 80°. The polarizer 46F is a polarizer of which an angle of a transmission axis is set to 100°. The polarizer 46G is a polarizer of which an angle of a transmission axis is set to 120°. The polarizer 46H is a polarizer of which an angle of a transmission axis is set to 140°. Hereinafter, each of the polarizer 46A to the polarizer 46H will be referred to as a “polarizer 46” unless necessary to distinguish the polarizer 46A to the polarizer 46H from each other.

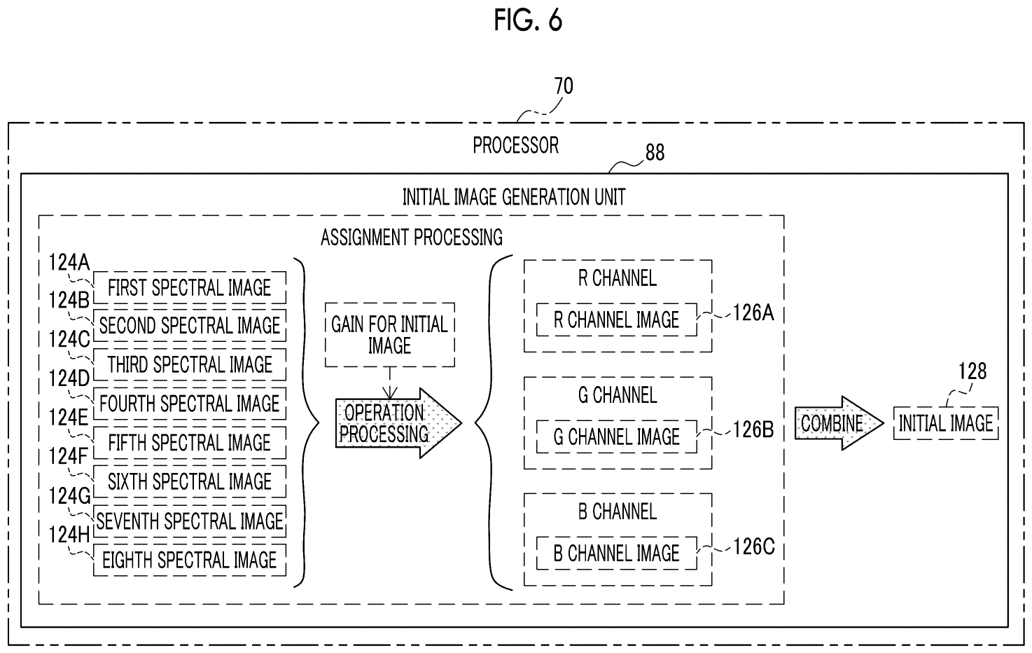

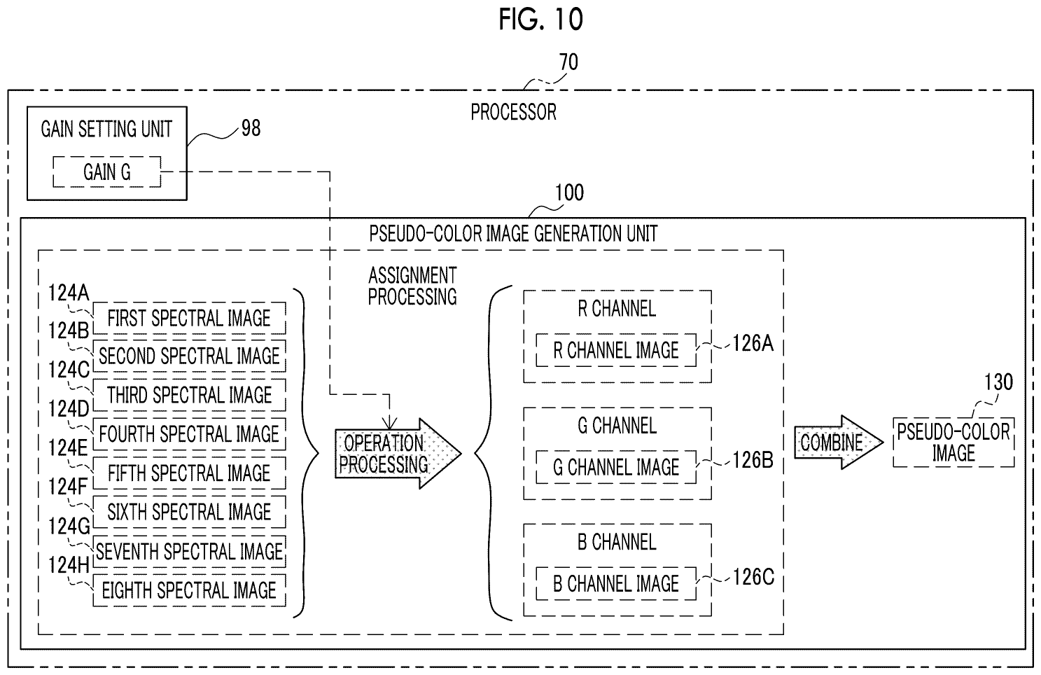

While the number of filters 44 is eight in the example illustrated in FIG. 1, the number of filters 44 may be any number greater than or equal to the number of channels (refer to FIGS. 6 and 10) described later. In addition, while the number of polarizers 46 is eight in the example illustrated in FIG. 1, the number of polarizers 46 may be any number equal to the number of filters 44.

The image sensor 14 comprises the photoelectric conversion element 48 and a signal processing circuit 50. The image sensor 14 is, for example, a CMOS image sensor. While a CMOS image sensor is illustrated as the image sensor 14 in the present embodiment, the disclosed technology is not limited to this. For example, the disclosed technology is also established in a case where the image sensor 14 is an image sensor of another type such as a CCD image sensor.

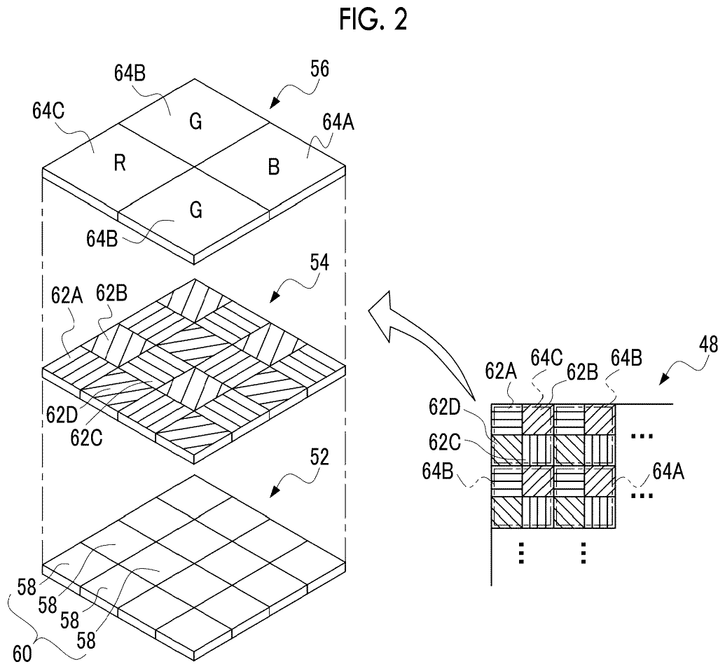

For example, FIG. 1 illustrates a schematic configuration of the photoelectric conversion element 48. In addition, for example, FIG. 2 specifically illustrates a configuration of a part of the photoelectric conversion element 48. The photoelectric conversion element 48 includes a pixel layer 52, a polarizing filter layer 54, and a spectral filter layer 56.

The pixel layer 52 includes a plurality of pixels 58. The plurality of pixels 58 are disposed in a matrix and form the light-receiving surface 48A of the photoelectric conversion element 48. Each pixel 58 is a physical pixel including a photodiode (not illustrated), and photoelectrically converts received light and outputs an electric signal corresponding to a received light quantity.

Hereinafter, the pixels 58 provided in the photoelectric conversion element 48 will be referred to as “physical pixels 58” in order to distinguish the pixels 58 from pixels forming the multispectral image. In addition, pixels forming an image displayed on the display 24 will be referred to as “image pixels”.

The photoelectric conversion element 48 outputs the electric signals output from the plurality of physical pixels 58 to the signal processing circuit 50 as imaging data 120. The signal processing circuit 50 converts the analog imaging data 120 input from the photoelectric conversion element 48 into a digital form.

The plurality of physical pixels 58 form a plurality of pixel blocks 60. Each pixel block 60 is formed with a total of four physical pixels 58 of two in a longitudinal direction by two in a lateral direction. While a state where the four physical pixels 58 forming each pixel block 60 are arranged in a straight line along the direction orthogonal to the optical axis OA is illustrated in FIG. 1 for convenience, the four physical pixels 58, for example, as illustrated in FIG. 2, are disposed adjacent to each other in a longitudinal direction and a lateral direction of the photoelectric conversion element 48.

The polarizing filter layer 54 includes a polarizer 62A to a polarizer 62D. The polarizer 62A is a polarizer of which an angle of a transmission axis is set to 0°. The polarizer 62B is a polarizer of which an angle of a transmission axis is set to 45°. The polarizer 62C is a polarizer of which an angle of a transmission axis is set to 90°. The polarizer 62D is a polarizer of which an angle of a transmission axis is set to 135°. Hereinafter, the polarizer 62A to the polarizer 62D will be referred to as “polarizers 62” unless necessary to distinguish the polarizer 62A to the polarizer 62D from each other.

The spectral filter layer 56 includes a B filter 64A, a G filter 64B, and an R filter 64C. The B filter 64A is a blue color range filter that mostly allows transmission of light having a wavelength range of a blue color in light having a plurality of wavelength ranges. The G filter 64B is a green color range filter that mostly allows transmission of light having a wavelength range of a green color in light having a plurality of wavelength ranges. The R filter 64C is a red color range filter that mostly allows transmission of light having a wavelength range of a red color in light having a plurality of wavelength ranges. The B filter 64A, the G filter 64B, and the R filter 64C are assigned to each pixel block 60.

While a state where the B filter 64A, the G filter 64B, and the R filter 64C are arranged in a straight line along the direction orthogonal to the optical axis OA is illustrated in FIG. 1 for convenience, the B filter 64A, the G filter 64B, and the R filter 64C, for example, as illustrated in FIG. 2, are disposed in a matrix in a predetermined pattern arrangement. In the example illustrated in FIG. 2, the B filter 64A, the G filter 64B, and the R filter 64C are disposed in a matrix in a Bayer arrangement as an example of the predetermined pattern arrangement. The predetermined pattern arrangement may be an RGB stripe arrangement, an R/G checkered arrangement, an X-Trans (registered trademark) arrangement, a honeycomb arrangement, or the like other than the Bayer arrangement.

Hereinafter, each of the B filter 64A, the G filter 64B, and the R filter 64C will be referred to as a “filter 64” unless necessary to distinguish the B filter 64A, the G filter 64B, and the R filter 64C from each other.

For example, as illustrated in FIG. 1, the signal processing circuit 50, the control driver 16, the computer 20, the reception device 22, and the display 24 are connected to the input-output I/F 18.

The computer 20 includes a processor 70, an NVM 72, and a RAM 74. The processor 70 is an example of a “processor” according to the disclosed technology. The processor 70 controls the entire imaging apparatus 10. The processor 70 is, for example, an operation processing device including a CPU and a GPU, and the GPU operates under control of the CPU and executes processing related to images. While an operation processing device including a CPU and a GPU is illustrated as an example of the processor 70, this is merely an example. The processor 70 may be one or more CPUs integrated with a GPU function or may be one or more CPUs not integrated with a GPU function. The processor 70, the NVM 72, and the RAM 74 are connected through a bus 76, and the bus 76 is connected to the input-output I/F 18.

The NVM 72 is a non-transitory storage medium and stores various parameters and various programs. For example, the NVM 72 is a flash memory (for example, an EEPROM). However, this is merely an example, and an HDD or the like together with a flash memory may be applied as the NVM 72. The RAM 74 temporarily stores various types of information and is used as a work memory.

The processor 70 reads out a necessary program from the NVM 72 and executes the read program in the RAM 74. The processor 70 controls the control driver 16 and the signal processing circuit 50 in accordance with the program executed in the RAM 74. The control driver 16 controls the photoelectric conversion element 48 under control of the processor 70.

The reception device 22 includes, for example, a release button, a touch panel, and a hard key (none illustrated) and receives an instruction from a user or the like. The display 24 is, for example, a liquid crystal display and displays various images.

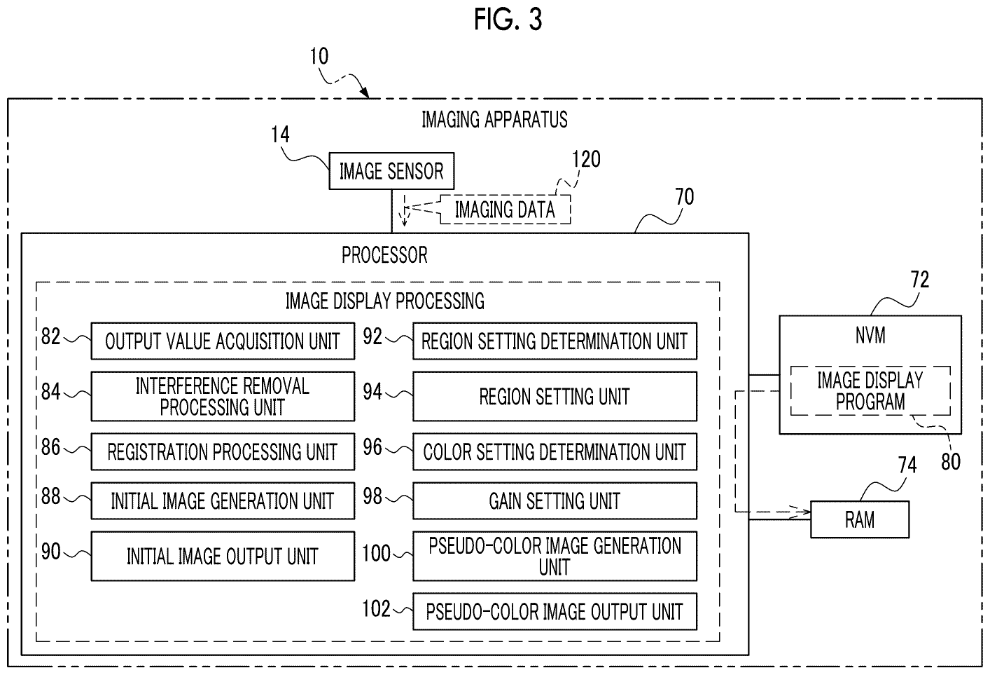

For example, as illustrated in FIG. 3, an image display program 80 is stored in the NVM 72. The image display program 80 is an example of a “program” according to the disclosed technology. The processor 70 reads out the image display program 80 from the NVM 72 and executes the read image display program 80 on the RAM 74. The processor 70 executes image display processing on the imaging data 120 in accordance with the image display program 80 executed on the RAM 74. The image display processing is an example of a “specific process” according to the disclosed technology.

The image display processing is implemented by causing the processor 70 to operate as an output value acquisition unit 82, an interference removal processing unit 84, a registration processing unit 86, an initial image generation unit 88, an initial image output unit 90, a region setting determination unit 92, a region setting unit 94, a color setting determination unit 96, a gain setting unit 98, a pseudo-color image generation unit 100, and a pseudo-color image output unit 102 in accordance with the image display program 80. The image display processing starts each time the imaging data 120 is input into the processor 70 from the image sensor 14.

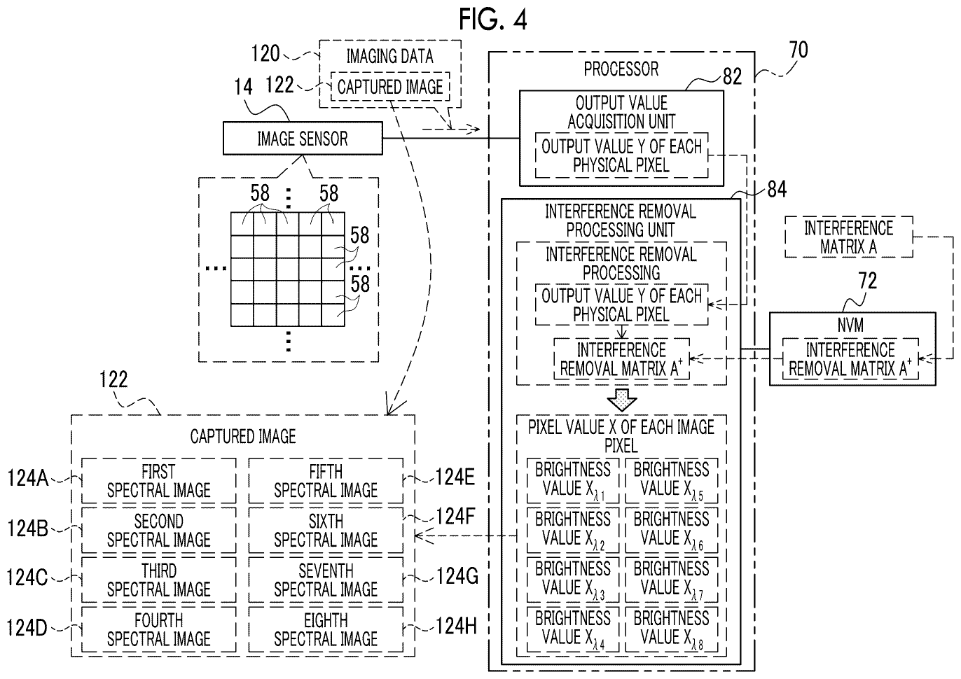

For example, as illustrated in FIG. 4, the output value acquisition unit 82 acquires an output value Y of each physical pixel 58 based on the imaging data 120 input into the processor 70 from the image sensor 14. The output value Y of each physical pixel 58 corresponds to a brightness value of each pixel included in a captured image 122 indicated by the imaging data 120.

The output value Y of each physical pixel 58 is a value including interference (that is, crosstalk). That is, since light having each transmission wavelength range λ including the first transmission wavelength range λ₁, the second transmission wavelength range λ₂, and the third transmission wavelength range λ₃ is incident on each physical pixel 58, the output value Y is a value in which a value corresponding to a light quantity of the first transmission wavelength range λ₁, a value corresponding to a light quantity of the second transmission wavelength range λ₂, and a value corresponding to a light quantity of the third transmission wavelength range λ₃ are mixed.

In order to acquire the multispectral image, the processor 70 is required to perform processing of separating and extracting the value corresponding to each transmission wavelength range λ from the output value Y, that is, interference removal processing of removing the interference, on the output value Y for each physical pixel 58. Therefore, in the present embodiment, the interference removal processing unit 84 executes the interference removal processing on the output value Y of each physical pixel 58 acquired by the output value acquisition unit 82.

The interference removal processing will be described. The output value Y of each physical pixel 58 includes a brightness value of each of the red color, the green color, and the blue color as components of the output value Y. The output value Y of each physical pixel 58 is represented by Expression (1).

$$\\ \begin{matrix}Y = ( \begin{matrix}{Y}_{R} \\ {Y}_{G} \\ {Y}_{B}\end{matrix} ) & ( 1 )\end{matrix}$$

Y_{R} is the brightness value of the red color in the output value Y. Y_{G} is the brightness value of the green color in the output value Y. Y_{B} is the brightness value of the blue color in the output value Y.

A first spectral image 124A to an eighth spectral image 124H are images generated by performing the interference removal processing on the captured image. A pixel value X of each image pixel included in the first spectral image 124A to the eighth spectral image 124H before being pseudo-colored as described later includes a brightness value of light having each of the first transmission wavelength range λ₁ to the eighth transmission wavelength range λ₈ as components of the pixel value X. The pixel value X of each image pixel is represented by Expression (2).

$$\\ \begin{matrix}X = ( \begin{matrix}{X}_{λ 1} \\ {X}_{λ 2} \\ {X}_{λ 3} \\ {X}_{λ 4} \\ {X}_{λ 5} \\ {X}_{λ 6} \\ {X}_{λ 7} \\ {X}_{λ 8}\end{matrix} ) & ( 2 )\end{matrix}$$

A brightness value X_{λ1} is the brightness value of light having the first transmission wavelength range λ₁ in the pixel value X. A brightness value X_{λ2} is the brightness value of light having the second transmission wavelength range λ₂ in the pixel value X. A brightness value X_{λ3} is the brightness value of light having the third transmission wavelength range λ₃ in the pixel value X. A brightness value X_{λ4} is the brightness value of light having the fourth transmission wavelength range λ₄ in the pixel value X.

A brightness value X_{λ5} is the brightness value of light having the fifth transmission wavelength range λ₅ in the pixel value X. A brightness value X_{λ6} is the brightness value of light having the sixth transmission wavelength range λ₆ in the pixel value X. A brightness value X_{λ7} is the brightness value of light having the seventh transmission wavelength range λ₇ in the pixel value X. A brightness value X_{λ8} is the brightness value of light having the eighth transmission wavelength range λ₈ in the pixel value X. Hereinafter, the brightness value Xx to the brightness value X_{λ8} will be referred to as “brightness values X_{λ}” unless necessary to distinguish the brightness value X_{λ1} to the brightness value X_{λ8} from each other.

In a case where an interference matrix is denoted by A, the output value Y of each physical pixel 58 is represented by Expression (3).

$$\\ \begin{matrix}Y = A \times X & ( 3 )\end{matrix}$$

The interference matrix A is a matrix that is defined based on a spectrum of the subject light, spectral transmittance of the first lens 26, spectral transmittance of the second lens 30, spectral transmittance of the plurality of filters 44, and spectral sensitivity of the image sensor 14.

In a case where an interference removal matrix that is a generalized inverse matrix of the interference matrix A is denoted by A⁺, the pixel value X of each image pixel is represented by Expression (4).

$$\\ \begin{matrix}X = {A}^{{}_{} +} \times Y & ( 4 )\end{matrix}$$

Like the interference matrix A, the interference removal matrix A⁺ is also a matrix that is defined based on the spectrum of the subject light, the spectral transmittance of the first lens 26, the spectral transmittance of the second lens 30, the spectral transmittance of the plurality of filters 44, and the spectral sensitivity of the image sensor 14. The interference removal matrix A⁺ is set by the user or the like and is stored in advance in the NVM 72.

The interference removal processing unit 84 acquires the interference removal matrix A⁺ stored in the NVM 72 and the output value Y of each physical pixel 58 acquired by the output value acquisition unit 82. The interference removal processing unit 84 calculates and outputs the pixel value X of each image pixel using Expression (4) based on the acquired interference removal matrix A⁺ and on the acquired output value Y of each physical pixel 58.

As described above, the pixel value X of each image pixel includes the brightness value of light having each of the first transmission wavelength range λ₁ to the eighth transmission wavelength range λ₈ as the components of the pixel value X.

The first spectral image 124A of the captured image 122 is an image corresponding to the brightness value X_{λ1} of light having the first transmission wavelength range λ₁ (that is, an image based on the brightness value X_{λ1}). The second spectral image 124B of the captured image 122 is an image corresponding to the brightness value X_{λ2} of light having the second transmission wavelength range λ₂ (that is, an image based on the brightness value X_{λ2}). The third spectral image 124C of the captured image 122 is an image corresponding to the brightness value X_{λ3} of light having the third transmission wavelength range λ₃ (that is, an image based on the brightness value X_{λ3}). The fourth spectral image 124D of the captured image 122 is an image corresponding to the brightness value X_{λ4} of light having the fourth transmission wavelength range λ₄ (that is, an image based on the brightness value X_{λ4}).

The fifth spectral image 124E of the captured image 122 is an image corresponding to the brightness value X_{λ5} of light having the fifth transmission wavelength range λ₅ (that is, an image based on the brightness value X_{λ5}). The sixth spectral image 124F of the captured image 122 is an image corresponding to the brightness value X_{λ6} of light having the sixth transmission wavelength range λ₆ (that is, an image based on the brightness value X_{λ6}). The seventh spectral image 124G of the captured image 122 is an image corresponding to the brightness value X_{λ7} of light having the seventh transmission wavelength range λ₇ (that is, an image based on the brightness value X_{λ7}). The eighth spectral image 124H of the captured image 122 is an image corresponding to the brightness value X_{λ8} of light having the eighth transmission wavelength range λ₈ (that is, an image based on the brightness value X_{λ8}). Hereinafter, the first spectral image 124A to the eighth spectral image 124H will be referred to as “spectral images 124” unless necessary to distinguish the first spectral image 124A to the eighth spectral image 124H from each other.

By performing the interference removal processing via the interference removal processing unit 84, the captured image 122 is separated into the plurality of spectral images 124 corresponding to the brightness value X_{λ} of light having each of the first transmission wavelength range Mu to the eighth transmission wavelength range λ₈. That is, the captured image 122 is separated into the spectral images 124 for each transmission wavelength range λ of the plurality of filters 44. The plurality of spectral images 124 are images obtained by performing imaging via the image sensor 14 including the polarizers 46 and the filters 44 and include polarization information corresponding to the polarizers 46 and wavelength information corresponding to the filters 44. The number of the plurality of spectral images 124 is greater than or equal to the number of channels (refer to FIGS. 6 and 10) described later.

The plurality of spectral images 124 are examples of a “plurality of different spectral images” and a “first spectral image” according to the disclosed technology. The wavelength information is an example of “first wavelength information” according to the disclosed technology.

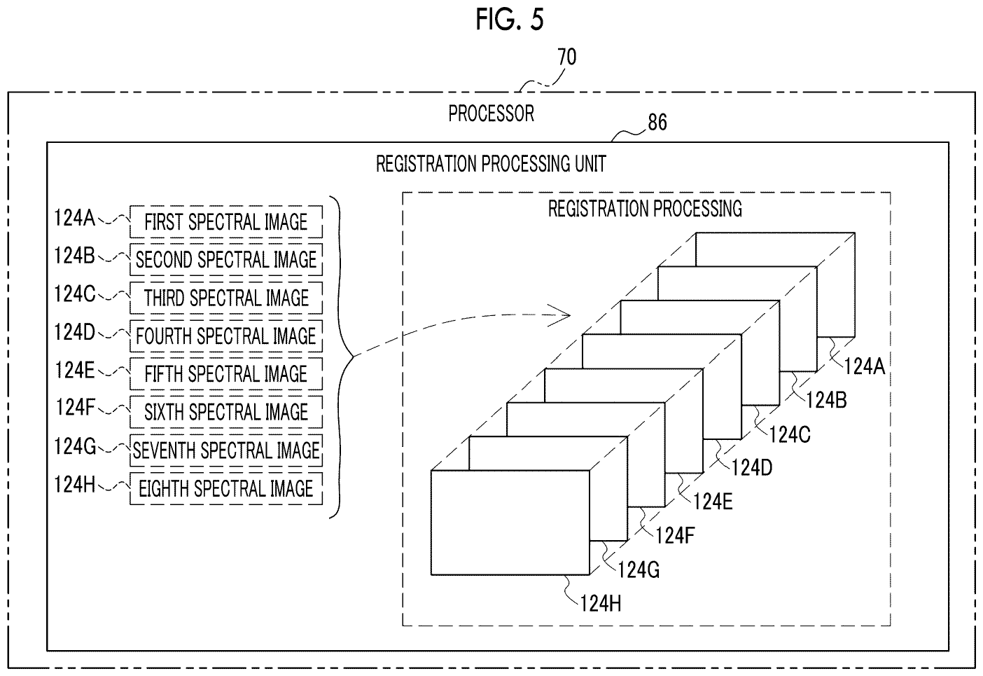

For example, as illustrated in FIG. 5, the registration processing unit 86 performs registration processing on the plurality of spectral images 124. The registration processing includes, for example, processing of correcting an optical distortion and/or processing of geometrically correcting a distortion in imaging. Examples of the processing of correcting the optical distortion include processing such as distortion correction (for example, correction of a barrel aberration or a pincushion aberration). Examples of the processing of geometrically correcting the distortion in imaging include processing such as keystone correction (that is, projective transformation, affine transformation, or the like).

For example, as illustrated in FIG. 6, the initial image generation unit 88 generates an R channel image 126A, a G channel image 126B, and a B channel image 126C for an R channel, a G channel, and a B channel, respectively, by performing assignment processing of assigning the plurality of different spectral images 124 to the R channel, the G channel, and the B channel. The initial image generation unit 88 generates an initial image 128 by combining the generated R channel image 126A, the generated G channel image 126B, and the generated B channel image 126C.

In the assignment processing performed by the initial image generation unit 88, the initial image generation unit 88 performs operation processing on the plurality of spectral images 124. In the operation processing, an operation using a gain is performed. The operation is a multiply-accumulate operation including the plurality of spectral images 124. That is, as illustrated in Expression (5), an image pixel component X_{R} assigned to the R channel of each image pixel included in the plurality of spectral images 124 is calculated as a total of products between a first gain G_{R1} to an eighth gain G_{R8} set for the R channel and the brightness values X_{λ1} to X_{λ8} of the transmission wavelength ranges λ₁ to λ₈. The first gain G_{R1} to the eighth gain G_{R8} are gains corresponding to the first transmission wavelength range λ₁ to the eighth transmission wavelength range λ₈, respectively.

$$\\ \begin{matrix}{X}_{R} = {G}_{R 1} \times {X}_{λ 1} + {G}_{R 2} \times {X}_{λ 2} + {G}_{R 3} \times {X}_{λ 3} + {G}_{R 4} \times {X}_{λ 4} + {G}_{R 5} \times {X}_{λ 5} + {G}_{R 6} \times {X}_{λ 6} + {G}_{R 7} \times {X}_{λ 7} + {G}_{R 8} \times {X}_{λ 8} & ( 5 )\end{matrix}$$

As illustrated in Expression (6), an image pixel component X_{G} assigned to the G channel of each image pixel included in the plurality of spectral images 124 is calculated as a total of products between a first gain G_{G1} to an eighth gain G_{G8} set for the G channel and the brightness values X_{λ1} to X_{λ8} of the transmission wavelength ranges λ₁ to λ₈. The first gain G_{G1} to the eighth gain G_{G8} are gains corresponding to the first transmission wavelength range λ₁ to the eighth transmission wavelength range λ₈, respectively.

$$\\ \begin{matrix}{X}_{G} = {G}_{G 1} \times {X}_{λ 1} + {G}_{G 2} \times {X}_{λ 2} + {G}_{G 3} \times {X}_{λ 3} + {G}_{G 4} \times {X}_{λ 4} + {G}_{G 5} \times {X}_{λ 5} + {G}_{G 6} \times {X}_{λ 6} + {G}_{G 7} \times {X}_{λ 7} + {G}_{G 8} \times {X}_{λ 8} & ( 6 )\end{matrix}$$

As illustrated in Expression (7), an image pixel component X_{B} assigned to the B channel of each image pixel included in the plurality of spectral images 124 is calculated as a total of products between a first gain G_{B1} to an eighth gain G_{B8} set for the B channel and the brightness values X_{λ1} to X_{λ8} of the transmission wavelength ranges λ₁ to λ₈. The first gain G_{B1} to the eighth gain G_{B8} are gains corresponding to the first transmission wavelength range λ₁ to the eighth transmission wavelength range λ₈, respectively.

$$\\ \begin{matrix}{X}_{B} = {G}_{B 1} \times {X}_{λ 1} + {G}_{B 2} \times {X}_{λ 2} + {G}_{B 3} \times {X}_{λ 3} + {G}_{B 4} \times {X}_{λ 4} + {G}_{B 5} \times {X}_{λ 5} + {G}_{B 6} \times {X}_{λ 6} + {G}_{B 7} \times {X}_{λ 7} + {G}_{B 8} \times {X}_{λ 8} & ( 7 )\end{matrix}$$

By calculating the image pixel components X_{R}, X_{G}, and X_{B} of each image pixel included in the plurality of spectral images 124, the plurality of spectral images 124 are assigned to the R channel, the G channel, and the B channel.

Table 1 shows examples of the first gain G_{R1} to the eighth gain G_{R8} set for the R channel, the first gain G_{G1} to the eighth gain G_{G8} set for the G channel, and the first gain G_{B1} to the eighth gain G_{B8} set for the B channel in the assignment processing performed by the initial image generation unit 88. The gains shown in Table 1 are gains for the initial image 128.

TABLE 1

| | First | Second | Third | Fourth | Fifth | Sixth | Seventh | Eighth |
|---|---|---|---|---|---|---|---|---|
| | Gain | Gain | Gain | Gain | Gain | Gain | Gain | Gain |
| R Channel | 0 | 0 | 0 | 0 | 1 | 0 | 0 | 0 |
| G Channel | 0 | 0 | 1 | 0 | 0 | 0 | 0 | 0 |
| B Channel | 1 | 0 | 0 | 0 | 0 | 0 | 0 | 0 |

As shown in Table 1, in the R channel, the fifth gain G_{R5} corresponding to the fifth transmission wavelength range λ₅ that is a transmission wavelength range of the red color is set to “1”, and the remaining gains corresponding to the transmission wavelength ranges other than the fifth transmission wavelength range λ₅ are set to “0”. Accordingly, the R channel image 126A including only the brightness value X_{λ5} of red color light is obtained from the plurality of spectral images 124.

In the G channel, the third gain G_{G3} corresponding to the third transmission wavelength range λ₃ that is a transmission wavelength range of the green color is set to “1”, and the remaining gains corresponding to the transmission wavelength ranges other than the third transmission wavelength range λ₃ are set to “0”. Accordingly, the G channel image 126B including only the brightness value X_{λ3} of green color light is obtained from the plurality of spectral images 124.

In the B channel, the first gain G_{B1} corresponding to the first transmission wavelength range λ₁ that is a transmission wavelength range of the blue color is set to “1”, and the remaining gains corresponding to the transmission wavelength ranges other than the first transmission wavelength range λ are set to “0”. Accordingly, the B channel image 126C including only the brightness value X_{λ1} of blue color light is obtained from the plurality of spectral images 124.

The initial image 128 generated by combining the R channel image 126A, the G channel image 126B, and the B channel image 126C obtained as described above is a normal RGB image that is not pseudo-colored. The initial image 128 is an example of an “image generated based on the plurality of spectral images” according to the disclosed technology.

Hereinafter, each of the R channel, the G channel, and the B channel will be referred to as a “channel” unless necessary to distinguish the R channel, the G channel, and the B channel from each other. Each of the R channel image 126A, the G channel image 126B, and the B channel image 126C will be referred to as a “channel image 126” unless necessary to distinguish the R channel image 126A, the G channel image 126B, and the B channel image 126C from each other.

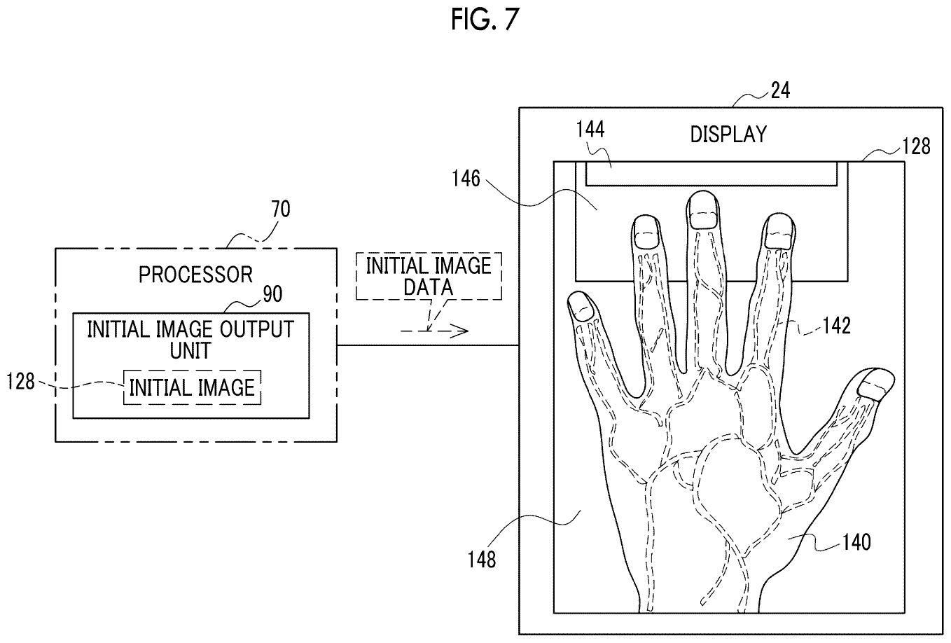

For example, as illustrated in FIG. 7, the initial image output unit 90 outputs initial image data indicating the initial image 128 generated by the initial image generation unit 88 to the display 24. The display 24 displays the initial image 128 based on the initial image data. For example, in the example illustrated in FIG. 7, the initial image 128 showing a left hand 140 of a person, a first object 144, a second object 146, and a background 148 is displayed on the display 24. The hand 140 includes a blood vessel 142.

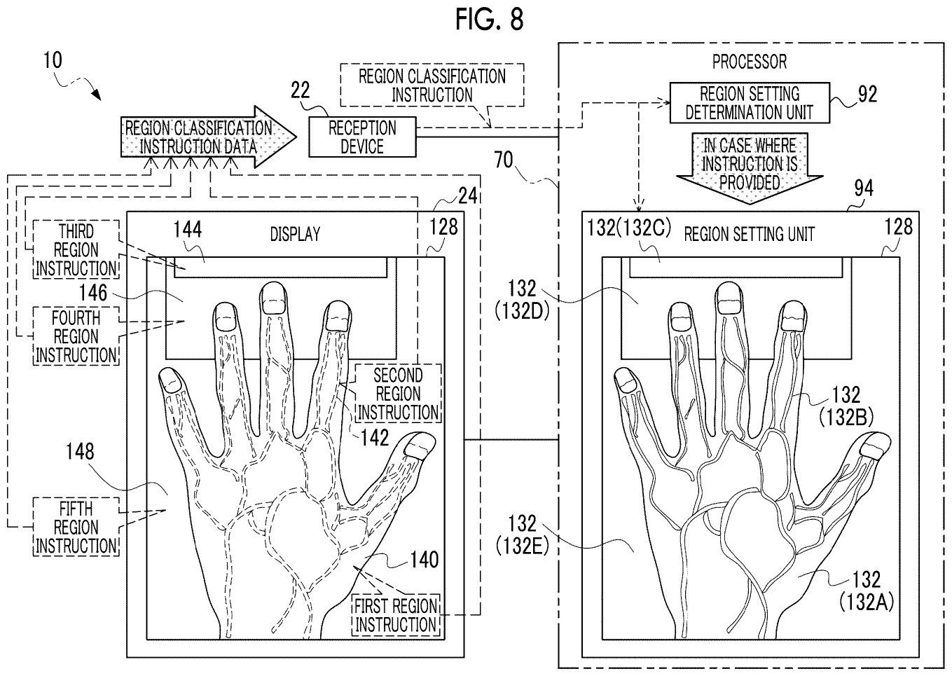

For example, as illustrated in FIG. 8, in a case where the initial image 128 is displayed on the display 24, the processor 70 sets an operation mode of the imaging apparatus 10 to a region classification mode in which the user or the like can classify the initial image 128 into a plurality of regions 132 through the reception device 22.

In a state where the initial image 128 is displayed on the display 24, the user or the like provides a region classification instruction for classifying the initial image 128 into the plurality of regions 132 to the reception device 22. The region classification instruction is provided to, for example, the touch panel included in the reception device 22.

In a case where the reception device 22 receives the region classification instruction, the reception device 22 outputs region classification instruction data indicating the region classification instruction to the processor 70. The region setting determination unit 92 determines whether or not the region classification instruction data is input into the processor 70.

In a case where the region setting determination unit 92 determines that the region classification instruction data is input to the processor 70, the region setting unit 94 classifies the initial image 128 into the plurality of regions 132 in accordance with the region classification instruction data. For example, various types of processing such as processing of detecting a boundary of an image included in the plurality of spectral images 124 and/or processing of classifying the plurality of regions 132 based on spectral characteristics stored in advance are used as processing of classifying the initial image 128 into the plurality of regions 132.

For example, in the example illustrated in FIG. 8, the region classification instruction includes a first region instruction, a second region instruction, a third region instruction, a fourth region instruction, and a fifth region instruction. The first region instruction is an instruction to designate a region 132 (hereinafter, referred to as a “first region 132A”) corresponding to a part of the hand 140 other than the blood vessel 142. The second region instruction is an instruction to designate a region 132 (hereinafter, referred to as a “second region 132B”) corresponding to the blood vessel 142 of the hand 140. The third region instruction is an instruction to designate a region 132 (hereinafter, referred to as a “third region 132C”) corresponding to the first object 144. The fourth region instruction is an instruction to designate a region 132 (hereinafter, referred to as a “fourth region 132D”) corresponding to the second object 146. The fifth region instruction is an instruction to designate a region 132 (hereinafter, referred to as a “fifth region 132E”) corresponding to the background 148.

In the example illustrated in FIG. 8, the initial image 128 is classified into the plurality of regions 132 in accordance with the first region instruction, the second region instruction, the third region instruction, the fourth region instruction, and the fifth region instruction. Specifically, the initial image 128 is classified into the first region 132A, the second region 132B, the third region 132C, the fourth region 132D, and the fifth region 132E. The first region 132A, the second region 132B, the third region 132C, the fourth region 132D, and the fifth region 132E reflect light having wavelength ranges different from each other and thus can be classified. The plurality of regions 132 are examples of a “plurality of regions” according to the disclosed technology.

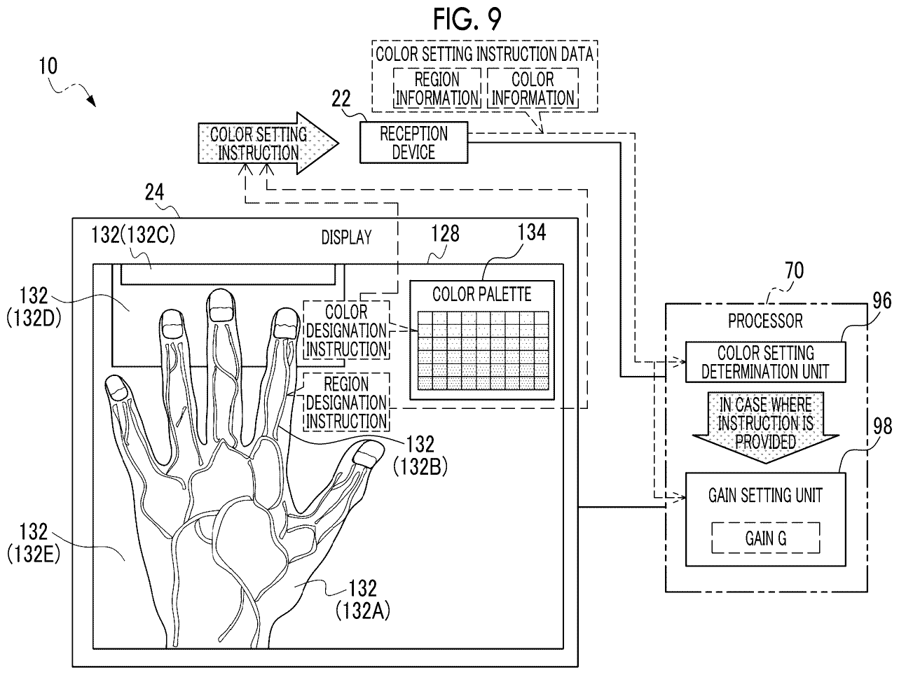

For example, as illustrated in FIG. 9, in a case where the initial image 128 is classified into the plurality of regions 132, the processor 70 sets the operation mode of the imaging apparatus 10 to a color setting mode in which the user or the like can set a color for each region 132 through the reception device 22. In a case where the operation mode of the imaging apparatus 10 is set to the color setting mode, a color palette 134 on which a plurality of colors can be selected is displayed on the display 24.

In a state where the color palette 134 is displayed on the display 24, the user or the like provides a color setting instruction for setting the color for each region 132 to the reception device 22. The color setting instruction includes a region designation instruction for designating a region 132 for setting the color among the plurality of regions 132 and a color designation instruction for designating the color to be set for the region 132 corresponding to the region designation instruction. The color setting instruction is provided to, for example, the touch panel (not illustrated) included in the reception device 22.

In a case where the color setting instruction is received, the reception device 22 outputs color setting instruction data indicating the color setting instruction to the processor 70. The color setting instruction data includes region information corresponding to the region designation instruction and color information corresponding to the color designation instruction. The color information is an example of “color information” according to the disclosed technology. The color setting determination unit 96 determines whether or not the color setting instruction data is input into the processor 70.

In a case where the color setting determination unit 96 determines that the color setting instruction data is input into the processor 70, the gain setting unit 98 sets a gain G for the plurality of spectral images 124 such that the color designated by the color designation instruction is set for the region 132 designated by the region designation instruction in accordance with the color setting instruction data.

A method of deriving the gain G will be described. A pixel value y of each image pixel included in a pseudo-color image 130 (refer to FIG. 10) generated based on the plurality of spectral images 124 is represented by Expression (8).

$$\\ \begin{matrix}y = ( \begin{matrix}{y}_{R 1} & {y}_{R 2} & {y}_{R 3} & {y}_{R 4} & {y}_{R 5} \\ {y}_{G 1} & {y}_{G 2} & {y}_{G 3} & {y}_{G 4} & {y}_{G 5} \\ {y}_{B 1} & {y}_{B 2} & {y}_{B 3} & {y}_{B 4} & {y}_{B 5}\end{matrix} ) & ( 8 )\end{matrix}$$

y_{R1} is a brightness value of the red color in the first region 132A. y_{R2} is a brightness value of the red color in the second region 132B. y_{R3} is a brightness value of the red color in the third region 132C, y_{R4} is a brightness value of the red color in the fourth region 132D. y_{R5} is a brightness value of the red color in the fifth region 132E.

y_{G1} is a brightness value of the green color in the first region 132A. y_{G2} is a brightness value of the green color in the second region 132B. y_{G3} is a brightness value of the green color in the third region 132C. y_{G4} is a brightness value of the green color in the fourth region 132D. y_{G5} is a brightness value of the green color in the fifth region 132E.

y_{B1} is a brightness value of the blue color in the first region 132A. y_{B2} is a brightness value of the blue color in the second region 132B. y_{B3} is a brightness value of the blue color in the third region 132C. y_{B4} is a brightness value of the blue color in the fourth region 132D. y_{B5} is a brightness value of the blue color in the fifth region 132E.

An average brightness value x of each region 132 is represented by Expression (9).

$$\\ \begin{matrix}x = ( \begin{matrix}{x}_{λ 1 - 1} & {x}_{λ 1 - 2} & {x}_{λ 1 - 3} & {x}_{λ 1 - 4} & {x}_{λ 1 - 5} \\ {x}_{λ 2 - 1} & {x}_{λ 2 - 2} & {x}_{λ 2 - 3} & {x}_{λ 2 - 4} & {x}_{λ 2 - 5} \\ {x}_{λ 3 - 1} & {x}_{λ 3 - 2} & {x}_{λ 3 - 3} & {x}_{λ 3 - 4} & {x}_{λ 3 - 5} \\ {x}_{λ 4 - 1} & {x}_{λ 4 - 2} & {x}_{λ 4 - 3} & {x}_{λ 4 - 4} & {x}_{λ 4 - 5} \\ {x}_{λ 5 - 1} & {x}_{λ 5 - 2} & {x}_{λ 5 - 3} & {x}_{λ 5 - 4} & {x}_{λ 5 - 5} \\ {x}_{λ 6 - 1} & {x}_{λ 6 - 2} & {x}_{λ 6 - 3} & {x}_{λ 6 - 4} & {x}_{λ 6 - 5} \\ {x}_{λ 7 - 1} & {x}_{λ 7 - 2} & {x}_{λ 7 - 3} & {x}_{λ 7 - 4} & {x}_{λ 7 - 5} \\ {x}_{λ 8 - 1} & {x}_{λ 8 - 2} & {x}_{λ 8 - 3} & {x}_{λ 8 - 4} & {x}_{λ 8 - 5}\end{matrix} ) & ( 9 )\end{matrix}$$

x_{λ1-1} is an average brightness value of light having the first transmission wavelength range λ₁ in the image pixels included in the first region 132A. x_{λ1-2} is an average brightness value of light having the first transmission wavelength range λ₁ in the image pixels included in the second region 132B. x_{λ1-3} is an average brightness value of light having the first transmission wavelength range λ in the image pixels included in the third region 132C. X_{λ1-4} is an average brightness value of light having the first transmission wavelength range λ₁ in the image pixels included in the fourth region 132D. x_{λ1-5} is an average brightness value of light having the first transmission wavelength range λ₁ in the image pixels included in the fifth region 132E.

x_{λ2-1} is an average brightness value of light having the second transmission wavelength range λ₂ in the image pixels included in the first region 132A. x_{λ2-2} is an average brightness value of light having the second transmission wavelength range λ₂ in the image pixels included in the second region 132B. x_{λ2-3} is an average brightness value of light having the second transmission wavelength range λ₂ in the image pixels included in the third region 132C. X_{λ2-4} is an average brightness value of light having the second transmission wavelength range λ₂ in the image pixels included in the fourth region 132D. X_{λ2-5} is an average brightness value of light having the second transmission wavelength range λ₂ in the image pixels included in the fifth region 132E.

x_{λ3-1} is an average brightness value of light having the third transmission wavelength range λ₃ in the image pixels included in the first region 132A. x_{λ3-2} is an average brightness value of light having the third transmission wavelength range λ₃ in the image pixels included in the second region 132B. x_{λ3-3} is an average brightness value of light having the third transmission wavelength range λ₃ in the image pixels included in the third region 132C. X_{λ3-4} is an average brightness value of light having the third transmission wavelength range λ₃ in the image pixels included in the fourth region 132D. x_{λ3-5} is an average brightness value of light having the third transmission wavelength range λ₃ in the image pixels included in the fifth region 132E.

x_{λ4-1} is an average brightness value of light having the fourth transmission wavelength range λ₄ in the image pixels included in the first region 132A. X_{λ4-2} is an average brightness value of light having the fourth transmission wavelength range λ₄ in the image pixels included in the second region 132B. X_{λ4-3} is an average brightness value of light having the fourth transmission wavelength range λ₄ in the image pixels included in the third region 132C. X_{λ4-4} is an average brightness value of light having the fourth transmission wavelength range λ₄ in the image pixels included in the fourth region 132D. X_{λ4-5} is an average brightness value of light having the fourth transmission wavelength range λ₄ in the image pixels included in the fifth region 132E.

x_{λ5-1} is an average brightness value of light having the fifth transmission wavelength range λ₅ in the image pixels included in the first region 132A. x_{λ5-2} is an average brightness value of light having the fifth transmission wavelength range λ₅ in the image pixels included in the second region 132B. x_{λ5-3} is an average brightness value of light having the fifth transmission wavelength range λ₅ in the image pixels included in the third region 132C. X_{λ5-4} is an average brightness value of light having the fifth transmission wavelength range λ₅ in the image pixels included in the fourth region 132D. x_{λ5-5} is an average brightness value of light having the fifth transmission wavelength range λ₅ in the image pixels included in the fifth region 132E.

x_{λ6-1} is an average brightness value of light having the sixth transmission wavelength range λ₆ in the image pixels included in the first region 132A. X_{λ6-2} is an average brightness value of light having the sixth transmission wavelength range λ₆ in the image pixels included in the second region 132B. X_{λ6-3} is an average brightness value of light having the sixth transmission wavelength range λ₆ in the image pixels included in the third region 132C. X_{λ6-4} is an average brightness value of light having the sixth transmission wavelength range λ₆ in the image pixels included in the fourth region 132D. x_{λ6-5} is an average brightness value of light having the sixth transmission wavelength range λ₆ in the image pixels included in the fifth region 132E.

x_{λ7-1} is an average brightness value of light having the seventh transmission wavelength range λ₇ in the image pixels included in the first region 132A. x_{λ7-2} is an average brightness value of light having the seventh transmission wavelength range λ₇ in the image pixels included in the second region 132B. x_{λ7-3} is an average brightness value of light having the seventh transmission wavelength range λ₇ in the image pixels included in the third region 132C. x_{λ7-4} is an average brightness value of light having the seventh transmission wavelength range λ₇ in the image pixels included in the fourth region 132D. x_{λ7-5} is an average brightness value of light having the seventh transmission wavelength range λ₇ in the image pixels included in the fifth region 132E.

x_{λ8-1} is an average brightness value of light having the eighth transmission wavelength range λ₈ in the image pixels included in the first region 132A. x_{λ8-2} is an average brightness value of light having the eighth transmission wavelength range λ₈ in the image pixels included in the second region 132B. x_{λ8-3} is an average brightness value of light having the eighth transmission wavelength range λ₈ in the image pixels included in the third region 132C. X_{λ8-4} is an average brightness value of light having the eighth transmission wavelength range λ₈ in the image pixels included in the fourth region 132D. x_{λ8-5} is an average brightness value of light having the eighth transmission wavelength range λ₈ in the image pixels included in the fifth region 132E.

The pixel value y of each image pixel included in the pseudo-color image 130 is represented by Expression (10) using the gain G.

$$\\ \begin{matrix}y = G \times x & ( 10 )\end{matrix}$$

The gain G includes the first gain G_{R1} to the eighth gain G_{R8} set for the R channel, the first gain G_{G1} to the eighth gain G_{G8} set for the G channel, and the first gain G_{B1} to the eighth gain G_{B8} set for the B channel. The first gain G_{R1} to the eighth gain G_{R8} are gains corresponding to the first transmission wavelength range Mu to the eighth transmission wavelength range λ₈, respectively. The first gain G_{G1} to the eighth gain G_{G8} are gains corresponding to the first transmission wavelength range λ₁ to the eighth transmission wavelength range λ₈, respectively. The first gain G_{B1} to the eighth gain G_{B8} are gains corresponding to the first transmission wavelength range Mu to the eighth transmission wavelength range λ₈, respectively. The gain G is represented by Expression (11).

$$\\ \begin{matrix}G = ( \begin{matrix}{G}_{R 1} & {G}_{R 2} & {G}_{R 3} & {G}_{R 4} & {G}_{R 5} & {G}_{R 6} & {G}_{R 7} & {G}_{R 8} \\ {G}_{G 1} & {G}_{G 2} & {G}_{G 3} & {G}_{G 4} & {G}_{G 5} & {G}_{G 6} & {G}_{G 7} & {G}_{G 8} \\ {G}_{B 1} & {G}_{B 2} & {G}_{B 3} & {G}_{B 4} & {G}_{B 5} & {G}_{B 6} & {G}_{B 7} & {G}_{B 8}\end{matrix} ) & ( 11 )\end{matrix}$$

The pixel value y of each image pixel included in the pseudo-color image 130 is set based on the region 132 and the color designated by the region designation instruction and the color designation instruction. The color of the region 132 that is not designated by the region designation instruction and the color designation instruction is set based on the initial image 128.

The first gain G_{R1} to the eighth gain G_{R8}, the first gain G_{G1} to the eighth gain G_{G8}, and the first gain G_{B1} to the eighth gain G_{B8} are derived from Expression (8) to Expression (11).

The gain G is derived using the above calculation method in a case where the number of regions 132 classified by the region classification instruction is less than or equal to the number of transmission wavelength ranges λ. In a case where the number of regions 132 is greater than the number of transmission wavelength ranges λ, the gain G, for example, may be derived as an approximate solution by performing interpolation processing such as least squares. While the gain G is uniformly set for the plurality of image pixels included in each spectral image 124, the gain G may be individually set for each image pixel included in each spectral image 124.

Table 2 shows an example of the gain G derived in accordance with the color setting instruction (hereinafter, referred to as a “first color setting instruction”) for setting the blue color for the second region 132B. As shown in Table 2, the gain G derived in accordance with the first color setting instruction includes not only a positive gain but also a negative gain.

TABLE 2

| | First | Second | Third | Fourth | Fifth | Sixth | Seventh | Eighth |
|---|---|---|---|---|---|---|---|---|
| | Gain | Gain | Gain | Gain | Gain | Gain | Gain | Gain |
| R Channel | −0.11 | −5.42 | 0.24 | 12.87 | −7.49 | −4.71 | 5.96 | −0.31 |
| G Channel | −0.14 | −2.58 | 0.76 | 7.17 | −4.42 | −2.89 | 3.16 | −0.03 |
| B Channel | 1.09 | 7.43 | −0.47 | −16.99 | 10.60 | 6.78 | −7.77 | 0.28 |

FIG. 10 illustrates an example in which the pseudo-color image 130 is generated based on the gain G set by the gain setting unit 98. The pseudo-color image generation unit 100 generates the R channel image 126A, the G channel image 126B, and the B channel image 126C for each of the R channel, the G channel, and the B channel by performing the assignment processing of assigning the plurality of different spectral images 124 to the R channel, the G channel, and the B channel.

The R channel, the G channel, and the B channel are examples of “different channels” according to the disclosed technology. The assignment processing is an example of “assignment processing” according to the disclosed technology. The R channel image 126A, the G channel image 126B, and the B channel image 126C are examples of a “channel image” according to the disclosed technology. The pseudo-color image 130 is an example of a “first pseudo-color image” according to the disclosed technology.

In the assignment processing performed by the pseudo-color image generation unit 100, the pseudo-color image generation unit 100 performs operation processing on the plurality of spectral images 124. In the operation processing, an operation using the gain G set by the gain setting unit 98 is performed. The operation is a multiply-accumulate operation including the plurality of spectral images 124.

That is, as illustrated in Expression (5), the image pixel component X_{R} assigned to the R channel of each image pixel included in the plurality of spectral images 124 is calculated as the total of the products between the first gain G_{R1} to the eighth gain G_{R5} set for the R channel and the brightness values X_{λ1} to X_{λ8} of the transmission wavelength ranges λ₁ to λ₈.

As illustrated in Expression (6), the image pixel component X_{G} assigned to the G channel of each image pixel included in the plurality of spectral images 124 is calculated as the total of the products between the first gain G_{G1} to the eighth gain G_{G8} set for the G channel and the brightness values X_{λ1} to X_{λ8} of the transmission wavelength ranges A to λg.

As illustrated in Expression (7), the image pixel component X_{B} assigned to the B channel of each image pixel included in the plurality of spectral images 124 is calculated as the total of the products between the first gain G_{B1} to the eighth gain G_{B8} set for the B channel and the brightness values X_{λ1} to X_{λ8} of the transmission wavelength ranges λ₁ to λ₈.

As shown in Table 2, by including not only a positive gain but also a negative gain (that is, a negative value) in the gain G, an operation including subtraction is performed in the operation processing. By calculating the image pixel components X_{R}, X_{G}, and X_{B} of each image pixel included in the plurality of spectral images 124, the plurality of spectral images 124 are assigned to the R channel, the G channel, and the B channel. The pseudo-color image generation unit 100 generates the pseudo-color image 130 by combining the generated R channel image 126A, the generated G channel image 126B, and the generated B channel image 126C.

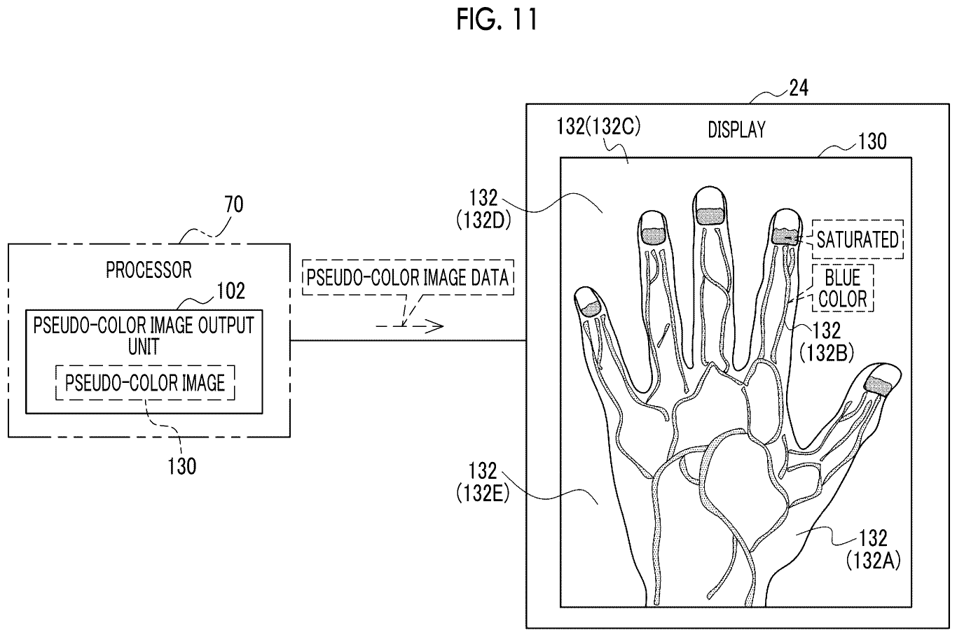

For example, as illustrated in FIG. 11, the pseudo-color image output unit 102 outputs pseudo-color image data indicating the pseudo-color image 130 generated by the pseudo-color image generation unit 100 to the display 24. The pseudo-color image data is an example of “data for displaying the first pseudo-color image” according to the disclosed technology. The display 24 displays the pseudo-color image 130 indicated by the pseudo-color image data.

For example, in the example illustrated in FIG. 11, the pseudo-color image 130 in which the blue color is set for the second region 132B is displayed on the display 24. In the example illustrated in FIG. 11, setting the blue color for the second region 132B saturates a color of the second region 132B at a fingertip of the hand 140. That is, an upper limit value of a range of the pseudo-color image 130 exceeds a representation range of the display 24. The representation range of the display 24 refers to a range of brightness that can be displayed on the display 24. The range of the pseudo-color image 130 refers to a range of brightness of the image pixels included in the pseudo-color image 130. The display 24 is an example of a “display medium” and a “display device” according to the disclosed technology.

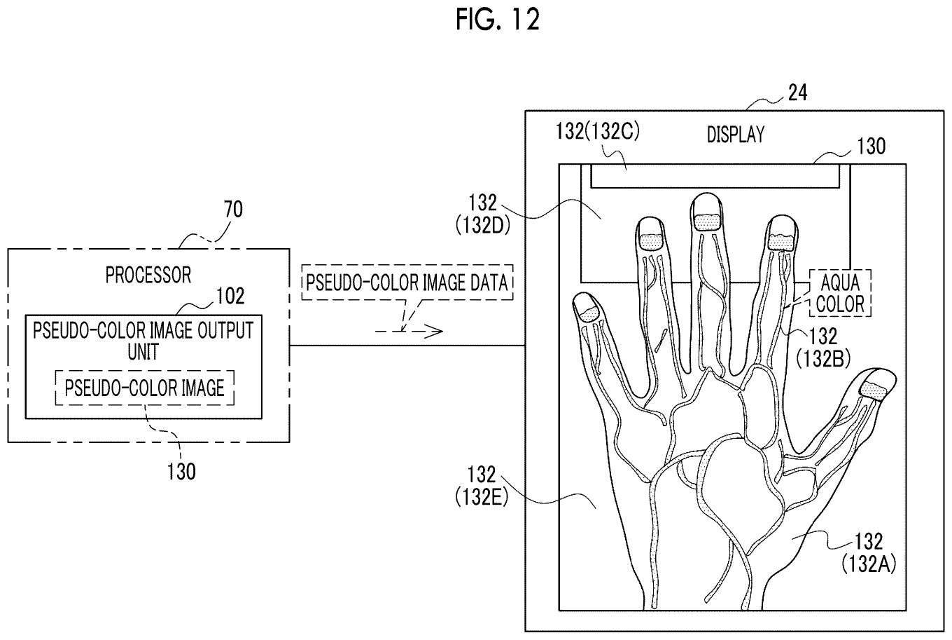

For example, FIG. 12 illustrates an example in which the pseudo-color image 130 is generated in accordance with the color setting instruction (hereinafter, referred to as a “second color setting instruction”) for setting an aqua color for the second region 132B instead of the blue color.

For example, as described above, in a case where the color of the second region 132B is saturated by setting the color of the second region 132B to the blue color, the color of the second region 132B may be changed to the aqua color from the blue color. In the example illustrated in FIG. 12, the saturation of the color of the second region 132B is avoided by changing the color of the second region 132B to the aqua color from the blue color.

Table 3 shows an example of the gain G derived in accordance with the second color setting instruction. As shown in Table 3, the gain G derived in accordance with the second color setting instruction includes not only a positive gain but also a negative gain. As shown in Table 3, by including not only a positive gain but also a negative gain (that is, a negative value) in the gain G, an operation including subtraction is performed in the operation processing (refer to FIG. 10).

TABLE 3

| | First | Second | Third | Fourth | Fifth | Sixth | Seventh | Eighth |
|---|---|---|---|---|---|---|---|---|
| | Gain | Gain | Gain | Gain | Gain | Gain | Gain | Gain |
| R Channel | −0.09 | −4.49 | 0.19 | 10.73 | −6.15 | −3.85 | 4.97 | −0.28 |
| G Channel | −0.10 | −0.38 | 0.64 | 2.06 | −1.23 | −0.84 | 0.82 | 0.05 |
| B Channel | 1.08 | 7.01 | −0.44 | −16.01 | 9.98 | 6.39 | −7.32 | 0.26 |

In the example illustrated in FIG. 12, the pseudo-color image 130 in which the aqua color is set for the second region 132B is generated. In a case where the color of the second region 132B is set to the aqua color, the gain G is set to a value with which the range of the pseudo-color image 130 falls within the representation range of the display 24 on which the pseudo-color image 130 is displayed. Accordingly, the saturation of the color of the second region 132B is avoided.

For example, in a case where a color that saturates a color of any region 132 among the plurality of regions 132 is designated, the gain setting unit 98 (refer to FIG. 9) may adjust the gain G such that the range of the pseudo-color image 130 falls within the representation range of the display 24.

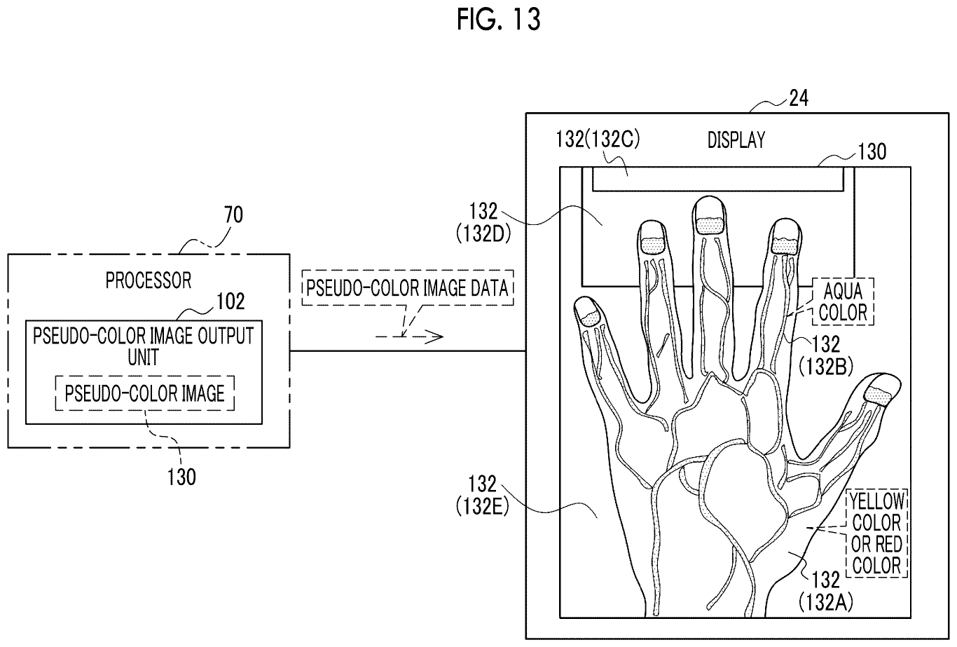

For example, FIG. 13 illustrates an example in which the pseudo-color image 130 is generated in accordance with the color setting instruction (hereinafter, referred to as a “third color setting instruction”) for setting a yellow color that is easily visible or the red color that is a complementary color to the aqua color for the first region 132A while setting the aqua color for the second region 132B.

Table 4 shows an example of the gain G derived in accordance with the third color setting instruction. As shown in Table 4, the gain G derived in accordance with the third color setting instruction includes not only a positive gain but also a negative gain. As shown in Table 4, by including not only a positive gain but also a negative gain (that is, a negative value) in the gain G, an operation including subtraction is performed in the operation processing (refer to FIG. 10).

TABLE 4

| | First | Second | Third | Fourth | Fifth | Sixth | Seventh | Eighth |
|---|---|---|---|---|---|---|---|---|
| | Gain | Gain | Gain | Gain | Gain | Gain | Gain | Gain |
| R Channel | −0.27 | −6.27 | 0.02 | 14.37 | −8.25 | −5.10 | 6.80 | −0.25 |
| G Channel | −0.61 | −5.34 | 0.16 | 12.24 | −7.10 | −4.35 | 5.92 | 0.12 |
| B Channel | 1.43 | 10.40 | −0.11 | −22.97 | 14.00 | 8.79 | −10.81 | 0.21 |

In the example illustrated in FIG. 13, the pseudo-color image 130 in which the aqua color is set for the second region 132B and the yellow color or the red color is set for the first region 132A is generated. In a case where the same color is set for different regions 132, the color of each of the different regions 132 may be saturated. Thus, it is preferable to set different colors for different regions 132. In the example illustrated in FIG. 13, the blood vessel 142 is highlighted with respect to the part of the hand 140 other than the blood vessel 142 by setting the aqua color for the second region 132B corresponding to the blood vessel 142 and setting the yellow color or the red color for the first region 132A corresponding to the part of the hand 140 other than the blood vessel 142.

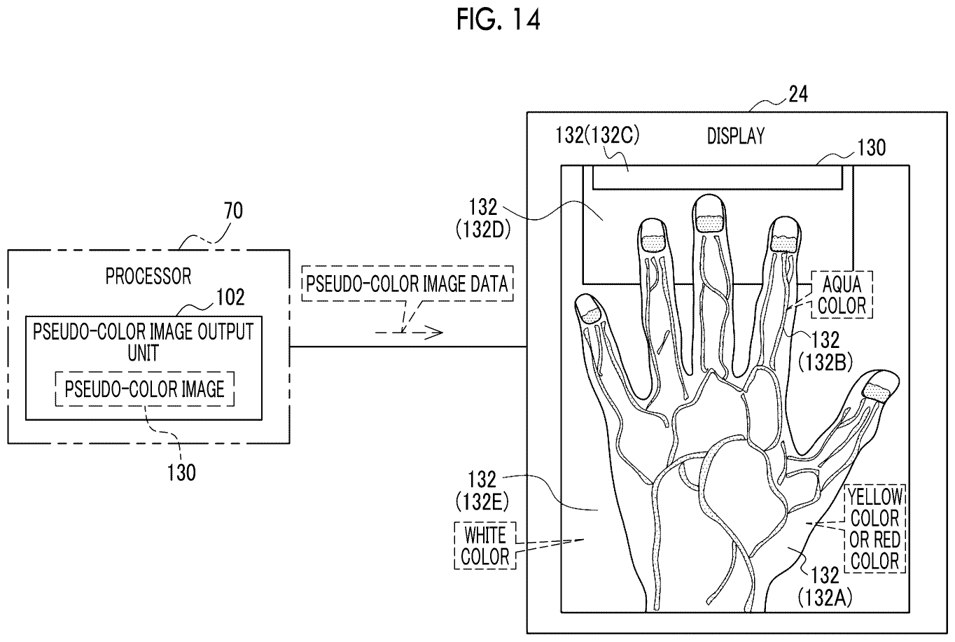

For example, FIG. 14 illustrates an example in which the pseudo-color image 130 is generated in accordance with the color setting instruction (hereinafter, referred to as a “fourth color setting instruction”) for setting a white color for the third region 132C while setting the aqua color for the second region 132B and setting the yellow color or the red color for the first region 132A. Colors of the fourth region 132D and the fifth region 132E are the same as colors of the fourth region 132D and the fifth region 132E in the initial image 128.

Table 5 shows an example of the gain G derived in accordance with the fourth color setting instruction. As shown in Table 5, the gain G derived in accordance with the fourth color setting instruction includes not only a positive gain but also a negative gain. As shown in Table 5, by including not only a positive gain but also a negative gain (that is, a negative value) in the gain G, an operation including subtraction is performed in the operation processing (refer to FIG. 10).

TABLE 5

| | First | Second | Third | Fourth | Fifth | Sixth | Seventh | Eighth |
|---|---|---|---|---|---|---|---|---|
| | Gain | Gain | Gain | Gain | Gain | Gain | Gain | Gain |
| R Channel | −2.26 | −3.71 | 1.74 | 9.14 | −7.11 | −4.44 | 5.01 | 2.67 |
| G Channel | −2.58 | −1.97 | 1.89 | 5.19 | −4.86 | −2.99 | 3.28 | 3.09 |
| B Channel | −0.46 | 13.04 | 1.83 | −28.03 | 14.88 | 9.22 | −12.64 | 3.09 |

In the example illustrated in FIG. 14, the pseudo-color image 130 in which the aqua color is set for the second region 132B, the yellow color or the red color is set for the first region 132A, and the white color is set for the third region 132C is generated. In the example illustrated in FIG. 14, the hand 140 and the blood vessel 142 are highlighted with respect to the background 148 by setting the white color for the third region 132C corresponding to the background 148.

The pseudo-color image 130 is, for example, an image in which discriminability of the wavelength information is increased with respect to a pseudo-color image (hereinafter, referred to as a “comparison target pseudo-color image”) for which only addition is included in the operation. Examples of the image in which the discriminability of the wavelength information is increased include an image that can be distinguished from the comparison target pseudo-color image by a color difference and/or a brightness difference.

The color difference refers to, for example, a complementary relationship on a color wheel. For example, in a case where one of two colors in a relationship with each other on the color wheel is used in the comparison target pseudo-color image, the other of the two colors in the relationship with each other on the color wheel is used in the pseudo-color image 130. A color used as a pseudo-color may also be set for a comparison target pseudo-color using a complementary color relationship between three primary colors of light and three primary colors of pigment. For the brightness difference, the pseudo-color image 130 may be represented in a brightness range of “0 to 50” in a case where, for example, the comparison target pseudo-color image is represented in a brightness range of “150 to 255”.

The comparison target pseudo-color image is an example of a “second pseudo-color image” according to the disclosed technology. The gain is an example of a “coefficient of the first spectral image” according to the disclosed technology. The wavelength information is an example of “second wavelength information” according to the disclosed technology.

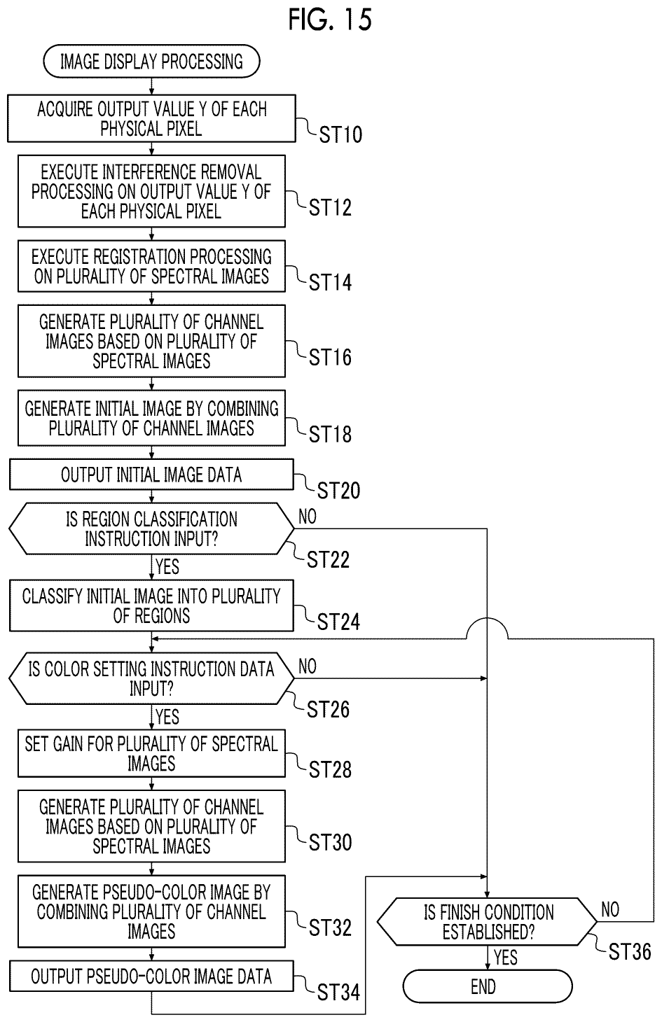

Next, an action of the imaging apparatus 10 according to the present embodiment will be described with reference to FIG. 15. FIG. 15 illustrates an example of a flow of the image display processing according to the present embodiment.

In the image display processing illustrated in FIG. 15, first, in step ST10, the output value acquisition unit 82 acquires the output value Y of each physical pixel 58 based on the imaging data 120 input into the processor 70 from the image sensor 14 (refer to FIG. 4). After the processing in step ST10 is executed, the image display processing transitions to step ST12.

In step ST12, the interference removal processing unit 84 executes the interference removal processing on the output value Y of each physical pixel 58 acquired in step ST10 (refer to FIG. 4). Accordingly, the captured image 122 indicated by the imaging data 120 is separated into the spectral images 124 for each transmission wavelength range λ of the plurality of filters 44. After the processing in step ST12 is executed, the image display processing transitions to step ST14.

In step ST14, the registration processing unit 86 performs the registration processing on the plurality of spectral images 124 generated in step ST12 (refer to FIG. 5). After the processing in step ST14 is executed, the image display processing transitions to step ST16.

In step ST16, the initial image generation unit 88 generates the R channel image 126A, the G channel image 126B, and the B channel image 126C for each of the R channel, the G channel, and the B channel by performing the assignment processing of assigning the plurality of spectral images 124 on which the registration processing is performed in step ST14 to the R channel, the G channel, and the B channel (refer to FIG. 6). After the processing in step ST16 is executed, the image display processing transitions to step ST18.

In step ST18, the initial image generation unit 88 generates the initial image 128 by combining the R channel image 126A, the G channel image 126B, and the B channel image 126C generated in step ST16 (refer to FIG. 6). After the processing in step ST18 is executed, the image display processing transitions to step ST20.

In step ST20, the initial image output unit 90 outputs the initial image data indicating the initial image 128 generated in step ST18 to the display 24 (refer to FIG. 7). Accordingly, the initial image 128 is displayed on the display 24. After the processing in step ST20 is executed, the image display processing transitions to step ST22.

In step ST22, the region setting determination unit 92 determines whether or not the region classification instruction data is input into the processor 70 (refer to FIG. 8). In a case where the region classification instruction data is not input into the processor 70, a negative determination is made, and the image display processing transitions to step ST36. In a case where the region classification instruction data is input into the processor 70, a positive determination is made, and the image display processing transitions to step ST24.

In step ST24, the region setting unit 94 classifies the initial image 128 into the plurality of regions 132 in accordance with the region classification instruction data (refer to FIG. 8). After the processing in step ST24 is executed, the image display processing transitions to step ST26.

In step ST26, the color setting determination unit 96 determines whether or not the color setting instruction data is input into the processor 70 (refer to FIG. 9). In a case where the color setting instruction data is not input into the processor 70, a negative determination is made, and the image display processing transitions to step ST36. In a case where the color setting instruction data is input into the processor 70, a positive determination is made, and the image display processing transitions to step ST28.

In step ST28, the gain setting unit 98 sets the gain G for the plurality of spectral images 124 such that the color designated by the color designation instruction is set for the region 132 designated by the region designation instruction in accordance with the color setting instruction data (refer to FIG. 9). After the processing in step ST28 is executed, the image display processing transitions to step ST30.

In step ST30, the pseudo-color image generation unit 100 generates the R channel image 126A, the G channel image 126B, and the B channel image 126C for each of the R channel, the G channel, and the B channel by performing the operation processing on the plurality of spectral images 124 based on the gain G set in step ST28 (refer to FIG. 10). Accordingly, the plurality of spectral images 124 are assigned to the R channel, the G channel, and the B channel. After the processing in step ST30 is executed, the image display processing transitions to step ST32.

In step ST32, the pseudo-color image generation unit 100 generates the pseudo-color image 130 by combining the R channel image 126A, the G channel image 126B, and the B channel image 126C generated in step ST30 (refer to FIG. 10). After the processing in step ST32 is executed, the image display processing transitions to step ST34.

In step ST34, the pseudo-color image output unit 102 outputs the pseudo-color image data indicating the pseudo-color image 130 generated in step ST32 to the display 24 (refer to FIG. 11). Accordingly, the pseudo-color image 130 is displayed on the display 24. After the processing in step ST34 is executed, the image display processing transitions to step ST36.

In step ST36, the processor 70 determines whether or not a condition (that is, a finish condition) under which the image display processing is finished is established. Examples of the finish condition include a condition that the user or the like provides an instruction to finish the image display processing to the imaging apparatus 10. In step ST36, in a case where the finish condition is not established, a negative determination is made, and the image display processing transitions to step ST26. In step ST36, in a case where the finish condition is established, a positive determination is made, and the image display processing is finished. The above method of the image display processing described as an action of the imaging apparatus 10 is an example of the “information processing method” according to the disclosed technology.

As described above, in the imaging apparatus 10 according to the present embodiment, the processor 70 generates the channel image 126 for each channel by performing the assignment processing of assigning the plurality of different spectral images 124 to the different channels and generates the pseudo-color image 130 based on the plurality of channel images 126 (refer to FIG. 10). The assignment processing includes processing of generating the channel images 126 based on an operation including subtraction for the plurality of spectral images 124. Accordingly, for example, color adjustment having a high degree of freedom in the pseudo-coloring of the plurality of spectral images 124 can be implemented, compared to a case where the channel images 126 are generated based on an operation including only addition for the plurality of different spectral images 124. Consequently, the pseudo-color image 130 that can be visually distinguished from the comparison target pseudo-color image generated by combining the channel images 126 generated based on the operation including only addition can be generated.

The operation is a multiply-accumulate operation including the plurality of spectral images 124, and the subtraction is implemented by including a negative value in the gains of the plurality of spectral images 124 in the multiply-accumulate operation. Accordingly, the color of the pseudo-color image 130 can be adjusted by adjusting values of the gains including a negative value and/or the number of gains including a negative value.

The gain G is set to a value with which the range of the pseudo-color image 130 falls within the representation range of the display 24 on which the pseudo-color image 130 is displayed. Accordingly, the saturation of the color set for the pseudo-color image 130 can be avoided.

The plurality of spectral images 124 include the polarization information and the wavelength information, and the number of the plurality of spectral images 124 is greater than or equal to the number of channels. Accordingly, for example, the degree of freedom in a case of adjusting the color of the pseudo-color image 130 can be increased, compared to a case where the number of the plurality of spectral images 124 is smaller than the number of channels.

The processor 70 performs the registration processing on the plurality of spectral images 124 obtained by imaging performed by the image sensor 14 including the plurality of polarizers 46, and the subtraction is performed on the plurality of spectral images 124 on which the registration processing is performed. The plurality of spectral images 124 are images obtained by imaging performed by the image sensor 14 including the plurality of polarizers 46. Thus, for example, a deviation in registration occurs in the plurality of spectral images 124. Accordingly, performing the registration processing on the plurality of spectral images 124 secures image quality of the initial image 128 (refer to FIG. 6) and the pseudo-color image 130 (refer to FIG. 10), compared to a case where the registration processing is not performed.

The pseudo-color image 130 is an image in which the discriminability of the wavelength information is increased with respect to the comparison target pseudo-color image for which only addition is included in the operation. Accordingly, the user or the like can visually distinguish the pseudo-color image 130 from the comparison target pseudo-color image.

The processor 70 classifies the image generated based on the plurality of spectral images 124 into the plurality of regions 132, and the operation is performed based on the color information set for the plurality of regions 132. Accordingly, the user or the like can set a color for each designated region 132 among the plurality of regions 132.

The different channels are channels of three primary colors. Accordingly, the pseudo-color image 130 can be generated based on the channels of the three primary colors.

The processor 70 outputs the pseudo-color image data for displaying the pseudo-color image 130 on the display 24. Accordingly, the user or the like can check a subject image included in the pseudo-color image 130 displayed on the display 24 with a color different from an original color of the subject image.

While the plurality of spectral images 124 are assigned to the R channel, the G channel, and the B channel corresponding to the three primary colors of pigment in the embodiment, the plurality of spectral images 124 may be assigned to channels corresponding to the three primary colors of light.

While the operation including the subtraction is performed on all of the spectral images 124 in the embodiment, the operation including the subtraction may be performed on spectral images 124 of a part of the plurality of spectral images 124.

While the plurality of spectral images 124 including the polarization information and the wavelength information are generated in the embodiment, the plurality of spectral images 124 including only one of the polarization information or the wavelength information may be generated.

While the initial image 128 and the pseudo-color image 130 are displayed on the display 24 comprised in the imaging apparatus 10 in the embodiment, the initial image 128 and the pseudo-color image 130 may be displayed on a display medium, a display device, or the like comprised in an external apparatus other than the imaging apparatus 10.

While, for example, the multispectral image generated based on light that is spectrally divided into eight transmission wavelength ranges λ has been illustratively described as an example of the multispectral image, the eight transmission wavelength ranges λ are merely an example, and the number of the plurality of transmission wavelength ranges λ may be any number.

The technology according to the embodiment may also be applied to apparatuses of types other than the imaging apparatus 10 (hereinafter, referred to as “other apparatuses”).

While the processor 70 is illustrated in the embodiment, another at least one CPU, at least one GPU, and/or at least one TPU may be used instead of the processor 70 or together with the processor 70.

While an example of a form in which the image display program 80 is stored in the NVM 72 has been illustratively described in the embodiment, the disclosed technology is not limited to this. For example, the image display program 80 may be stored in a portable non-transitory computer-readable storage medium (hereinafter, simply referred to as a “non-transitory storage medium”) such as an SSD or a USB memory. The image display program 80 stored in the non-transitory storage medium may be installed on the computer 20 of the imaging apparatus 10.

The image display program 80 may be stored in a storage device of another computer, a server apparatus, or the like connected to the imaging apparatus 10 through a network, and the image display program 80 may be downloaded in response to a request of the imaging apparatus 10 and installed on the computer 20.

The entire image display program 80 does not need to be stored in the storage device of another computer, a server apparatus, or the like connected to the imaging apparatus 10 or in the NVM 72, and a part of the image display program 80 may be stored.

While the computer 20 is incorporated in the imaging apparatus 10, the disclosed technology is not limited to this. For example, the computer 20 may be provided outside the imaging apparatus 10.

While the computer 20 including the processor 70, the NVM 72, and the RAM 74 is illustrated in the embodiment, the disclosed technology is not limited to this. A device including an ASIC, an FPGA, and/or a PLD may be applied instead of the computer 20. A combination of a hardware configuration and a software configuration may also be used instead of the computer 20.

Various processors illustrated below can be used as a hardware resource for executing various types of processing described in the embodiment. Examples of the processor include a CPU that is a general-purpose processor functioning as the hardware resource for executing the various types of processing by executing software, that is, a program. Examples of the processor also include a dedicated electronic circuit such as an FPGA, a PLD, or an ASIC that is a processor having a circuit configuration dedicatedly designed to execute specific processing. A memory is incorporated in or connected to any of the processors, and any of the processors execute the various types of processing using the memory.

The hardware resource for executing the various types of processing may be composed of one of the various processors or may be composed of a combination of two or more processors of the same type or different types (for example, a combination of a plurality of FPGAs or a combination of a CPU and an FPGA). The hardware resource for executing the various types of processing may be one processor.

Examples of the hardware resource composed of one processor include, first, a form of one processor composed of a combination of one or more CPUs and software, in which the processor functions as the hardware resource for executing the various types of processing. Second, as represented by an SoC or the like, a form of using a processor that implements functions of the entire system including a plurality of hardware resources for executing the various types of processing in one IC chip is included. Accordingly, the various types of processing are implemented using one or more of the various processors as the hardware resource.

More specifically, an electronic circuit in which circuit elements such as semiconductor elements are combined can be used as a hardware structure of the various processors. The image display processing is merely an example. Accordingly, it is, of course, possible to delete unnecessary steps, add new steps, or rearrange a processing order without departing from the gist of the disclosed technology.

Above described content and illustrated content are detailed description for parts according to the disclosed technology and are merely an example of the disclosed technology. For example, description related to the above configurations, functions, actions, and effects is description related to examples of configurations, functions, actions, and effects of the parts according to the disclosed technology. Thus, it is, of course, possible to remove unnecessary parts, add new elements, or replace parts in the above described content and the illustrated content without departing from the gist of the disclosed technology. In addition, particularly, description related to common technical knowledge or the like that is not required to be described for embodying the disclosed technology is omitted in the above described content and the illustrated content in order to avoid complication and facilitate understanding of the parts according to the disclosed technology.

In the present specification, “A and/or B” is synonymous with “at least one of A or B”. That is, “A and/or B” may mean only A, only B, or a combination of A and B. In the present specification, the same approach as “A and/or B” applies to a case where three or more matters are represented by connecting the matters with “and/or”.

All documents, patent applications, and technical standards disclosed in the present specification are incorporated in the present specification by reference to the same extent as in a case where each of the documents, patent applications, and technical standards are specifically and individually indicated to be incorporated by reference.

What is claimed is:

1. An information processing apparatus comprising:
a processor,
wherein the processor is configured to:
generate a channel image for each channel by performing assignment processing of assigning a plurality of different spectral images to different channels; and
generate a first pseudo-color image based on a plurality of the channel images,
the assignment processing includes processing of generating the channel image based on an operation including subtraction for a first spectral image among the plurality of spectral images,
the operation is a multiply-accumulate operation including the first spectral image, and
the subtraction is implemented by including a negative value in a coefficient of the first spectral image in the multiply-accumulate operation.

2. The information processing apparatus according to claim 1,
wherein the coefficient is set to a value with which a range of the first pseudo-color image falls within a representation range of a display medium on which the first pseudo-color image is displayed.

3. The information processing apparatus according to claim 1,
wherein the plurality of spectral images include polarization information and/or first wavelength information, and
the number of the plurality of spectral images is greater than or equal to the number of the channels.

4. The information processing apparatus according to claim 1,
wherein the plurality of spectral images are images obtained by imaging performed by an image sensor including a polarizer,
the processor is configured to perform registration processing on the first spectral image, and
the subtraction is performed on the first spectral image on which the registration processing is performed.

5. The information processing apparatus according to claim 1,
wherein the first pseudo-color image is an image in which discriminability of second wavelength information is increased with respect to a second pseudo-color image for which only addition is included in the operation.

6. The information processing apparatus according to claim 1,
wherein the processor is configured to classify an image generated based on the plurality of spectral images into a plurality of regions, and
the operation is performed based on color information set for the plurality of regions.

7. The information processing apparatus according to claim 1,
wherein the different channels are channels of three primary colors.

8. The information processing apparatus according to claim 1,
wherein the processor is configured to output data for displaying the first pseudo-color image to a display device.

9. An information processing method comprising:
generating a channel image for each channel by performing assignment processing of assigning a plurality of different spectral images to different channels; and
generating a first pseudo-color image based on a plurality of the channel images,
wherein the assignment processing includes processing of generating the channel image based on an operation including subtraction for a first spectral image among the plurality of spectral images,
the operation is a multiply-accumulate operation including the first spectral image, and
the subtraction is implemented by including a negative value in a coefficient of the first spectral image in the multiply-accumulate operation.

10. A non-transitory computer-readable storage medium storing a program for causing a computer to execute a specific process comprising:
generating a channel image for each channel by performing assignment processing of assigning a plurality of different spectral images to different channels; and
generating a first pseudo-color image based on a plurality of the channel images,
wherein the assignment processing includes processing of generating the channel image based on an operation including subtraction for a first spectral image among the plurality of spectral images,
the operation is a multiply-accumulate operation including the first spectral image, and
the subtraction is implemented by including a negative value in a coefficient of the first spectral image in the multiply-accumulate operation.
